(19) United States
(12) Patent Application Publication
(10) Pub. No.: US 2022/0168069 A1
(43) Pub. Date: Jun. 2, 2022

(54) REMOVABLE DENTAL APPLIANCES INCLUDING BENDABLE FLAPS AND ARCUATE MEMBERS

(71) Applicant: 3M INNOVATIVE PROPERTIES COMPANY, St. Paul, MN (US)

(72) Inventors: Richard E. Raby, Lino Lakes, MN (US); Eric S. Hansen, Apex, NC (US); Michael K. Domroese, Woodbury, MN (US); Chaodi Li, Woodbury, MN (US)

(21) Appl. No.: 17/601,109

(22) PCT Filed: Apr. 8, 2020
(86) PCT No.: PCT/IB2020/053375

§ 371 Date: Oct. 4, 2021

Related U.S. Application Data
(60) Provisional application No. 62/832,524, filed on Apr. 11, 2019.
(60) Provisional application No. 62/985,175, filed on Mar. 4, 2020.

(51) Int. Cl. A61C 7/08; A61C 13/34; A61C 9/00; A61C 7/00

(52) U.S. Cl. CPC A61C 7/08; A61C 7/002; A61C 9/004; A61C 13/34

(57) ABSTRACT

The invention relates to a removable dental appliance comprising an appliance body configured to at least partially surround a plurality of teeth of a patient. The appliance body defines a shell configured to receive a tooth of the plurality of teeth in an initial position and a bendable flap integrally formed with the appliance body to tether the flap to the shell. The bendable flap defines a boundary region around the bendable flap and includes abridge, wherein the bridge extends between the body and the flap at or adjacent the boundary region. In one specific embodiment, the bridge is an arcuate member and includes a spring bellows. The bendable flap and the bridge are configured to apply a force to the tooth to cause movement of the tooth toward a desired position when the removable dental appliance is worn by the patient.

### TECHNICAL FIELD

This disclosure relates to polymer-based removable dental appliances such as alignment trays.

### BACKGROUND

The field of orthodontics relates to repositioning teeth of a patient for improved function and aesthetic appearance. Orthodontic devices and treatment methods generally involve the application of forces to move teeth into a proper bite configuration, or occlusion. As one example, orthodontic treatment involves the use of slotted appliances, known as brackets, which are fixed to the patient's anterior, cuspid, and bicuspid teeth. An archwire is typically placed in the slot of each bracket and serves as a track to guide movement of the teeth to desired orientations. The ends of the archwire are usually received in appliances known as buccal tubes that are secured to the patient's molar teeth. Such dental appliances remain in the mouth of the patient and are periodically adjusted by an orthodontist to check the process and maintain the proper force levels on the teeth until proper alignment is achieved.

Orthodontic treatment may also involve the use of polymer-based tooth alignment trays, such as clear tray aligners (CTAs). For example, orthodontic treatment with CTAs includes forming a tray having shells that couple one or more teeth. Each shell is constructed in a position that is deformed from an initial position of a tooth, e.g., a maloccluded position. The deformed position of a respective shell of the CTA applies a force to a respective tooth toward a desired position for the tooth that is an intermediate position between the initial position and a final position resulting from the orthodontic treatment.

### SUMMARY

The details of one or more examples of this disclosure are set forth in the accompanying drawings and the description below. Other features, objects, and advantages of this disclosure will be apparent from the description and drawings, and from the claims.

### BRIEF DESCRIPTION OF THE DRAWINGS

FIGS. 1A-1E illustrate facial, oblique, and mesial cross-sectional views of an example removable dental appliance that includes a shell and a bendable flap including an arcuate member configured to apply a force to a tooth of a patient;

FIGS. 2A and 2B are conceptual diagrams illustrating an example removable dental appliance that includes bendable flaps having a spiral configuration;

FIGS. 3A-3C are conceptual diagrams illustrating an example removable dental appliance that includes a flap and a pair of spring bellows on opposing ends of the flap;

FIGS. 4A-4C are conceptual diagrams illustrating an example removable dental appliance that includes a bendable flap and a bridge including jumpers in a plane tangential to a surface of appliance body;

FIGS. 5A and 5B are conceptual diagrams illustrating an example removable dental appliance that includes a bendable flap extending from a slotted hinge axis and a plurality of jumpers bridging flap boundary region in a plane tangential to a surface of appliance body opposite the hinge axis;

FIGS. 6A and 6B are conceptual diagrams illustrating an example removable dental appliance that includes a bendable flap extending from a spring bellows extending around an entire flap boundary region;

FIGS. 7A and 7B are conceptual diagrams illustrating an example removable dental appliance that includes a bendable flap and a plurality of jumpers bridging the flap boundary region;

FIGS. 8A and 8B are conceptual diagrams illustrating an exemplary removable dental appliance that includes a bendable flap and a continuous spring bellows extending around an entire flap boundary region;

FIG. 9 is a block diagram illustrating an example computer environment in which a clinic and manufacturing facility communicate information throughout a dental appliance manufacturing process;

FIG. 10 is a flow diagram illustrating an example process of generating digital dental anatomy data;

FIG. 11 is a block diagram illustrating an example of a client computing device connected to a manufacturing facility via a network to generate digital dental anatomy data;

FIG. 12 is a block diagram illustrating an example computer-aided manufacturing system for construction of a removable dental appliance;

FIG. 13 is a flow diagram illustrating a process conducted at a manufacturing facility for construction of a set of removable dental appliances; and

FIG. 14 is a flow diagram illustrating successive iterations of treatment using an ordered set of removable dental appliances.

### DETAILED DESCRIPTION

This disclosure describes removable dental appliances that include at least one flap integrally formed with an appliance body and at least one bridge, which can be an arcuate member, disposed in a respective flap boundary region between the shell and a respective flap. The flap may be formed to extend from a hinge axis. Orthodontic treatment with the removable dental appliances includes the use of at least one flap and at least one bridge in the flap boundary region to enable greater control of force vectors applied to the teeth of the patient. The flap and bridge apply a force to a tooth to cause movement of the tooth toward a desired position when the removable dental appliance is worn by the patient. For example, a rest position of the flap may intrude into a space defined by the desired position of the tooth. The shell may include a surface that defines a void internal to the shell and shaped to receive the tooth in the desired position. During use of the removable dental appliance, the flap and bridge are displaced by the tooth into a deformed position to cause the force, while the surrounding shell remains substantially undeformed. The deformed flap and bridge apply the force to a side of the tooth opposite from the void to cause movement of the tooth toward the void. In this way, the removable dental appliance including a flap and bridge and optionally a hinge may be configured to concentrate deformation in at least one of the flap, the hinge axis, or the bridge.

By concentrating the deformation in at least one of the flap, the hinge axis, or the bridge, the shell may remain more highly engaged with the tooth. For example, when the removable dental appliance is in a deformed state, e.g., worn by the patient, the shells may have more points of contact with a respective tooth, a greater surface area of contact on a respective tooth, or the like, compared to a removable dental appliance without a flap. In this way, the removable dental appliance may improve engagement of the teeth in the shells, concentrate deformation in the flap and bridge, or both. By separating the force generating member (e.g., the flap and bridge) and the engagement member (e.g., the shell), the removable dental appliance enables greater control of forces applied to the teeth of a patient. In contrast, removable dental appliances that do not include at least one flap and bridge, or other similar features, the appliance body both engages a respective tooth and creates the force required to move the tooth during the course of orthodontic treatment. The degree of tooth engagement (e.g., the amount and positions of shell/tooth contact) affects control of the force applied to the tooth.

The flap and bridge are configured to control the magnitude, direction, and length of expression of the force applied to a respective tooth. For example, at least one of the position, shape, and dimensions of the flap and/or the bridge may result in a desired force vector on the respective tooth. The force vector may be applied to the tooth in a direction or a magnitude that may not be possible to apply to the tooth without the flap and bridge. The flap and the bridge also enable expression of a force over a greater distance than a removable dental appliance that relies on deformation of shells of the appliance to express force. For example, the rest position of the flap may extend into a space defined by the tooth in the desired position of the tooth such that, as the tooth moves into a void shaped to receive the tooth in the desired position, the flap continues to express the force of a sufficient magnitude to cause alveolar bone remodeling. Movement of the tooth results in partial relaxation of bending moments of the flap and/or the bridge. Some residual stress may remain in the flap and/or bridge to ensure positive force levels over the complete range of expression. In this way, the removable dental appliance may improve control of at least one of force vector direction, magnitude, or expression length, to achieve at least one of a desired tooth movement that may not be possible without the flap, a desired tooth movement over a shortened treatment time, a desired tooth movement with fewer progressions of removable dental appliances in a set of removable dental appliances, or the like, compared to other orthodontic treatments.

In some examples, each removable dental appliance of an ordered set of removable dental appliances may result in a greater expression, e.g., compared to a removable dental appliance without flaps and bridge(s) (e.g., arcuate members), due to the net shape (e.g., the arch shape of the tray and at least some of the individual cavities) of the appliance remaining relatively constant over the course of each treatment stage. Because the flaps and bridges may create force actuators that are isolated to individual teeth, only these focused portions of the appliance (the flaps and/or bridges) need to deform in order to apply directed forces to the teeth. As such, all other portions of the appliance can be made fairly rigid, thereby providing guided channels for tooth movement as well as bracing to resist deformation where movement is not desired. The amount of expression achievable by a single removable dental appliance may be limited by the depth of each tooth-receiving void and the elastic limit of bending possible by each bendable flap. For example, the amount of expression may be greater than 0.25 millimeter (mm) of crown movement, such as greater than 0.5 mm of crown movement or greater than 1 mm of crown movement. When coupled with robust materials that maintain their aesthetics and mechanical properties over a longer in vivo period compared to commonly used thermoplastics, greater expression and control may reduce the number of removable dental appliances in an ordered set of removable dental appliances required to achieve a selected tooth movement, e.g., due to more expression per removable dental appliance; reduce the number of office visits, e.g., due to increased doctor confidence in treatment progress; reduce treatment duration, e.g., due to more continuous and controllable tooth engagement forces and decreased round-tripping; and enable more accurate finishes, e.g., due to higher appliance rigidity and positive force application over the complete range of motion.

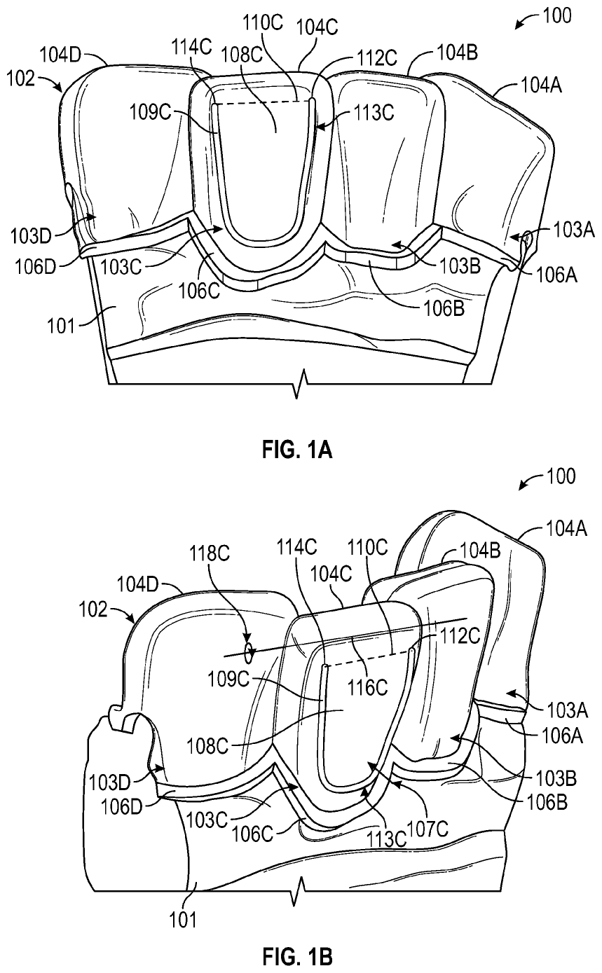

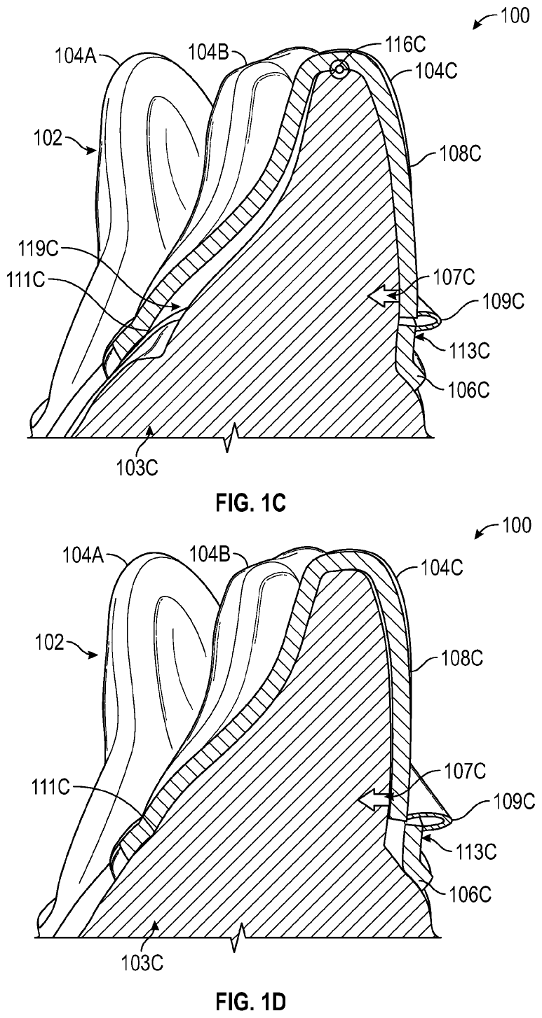

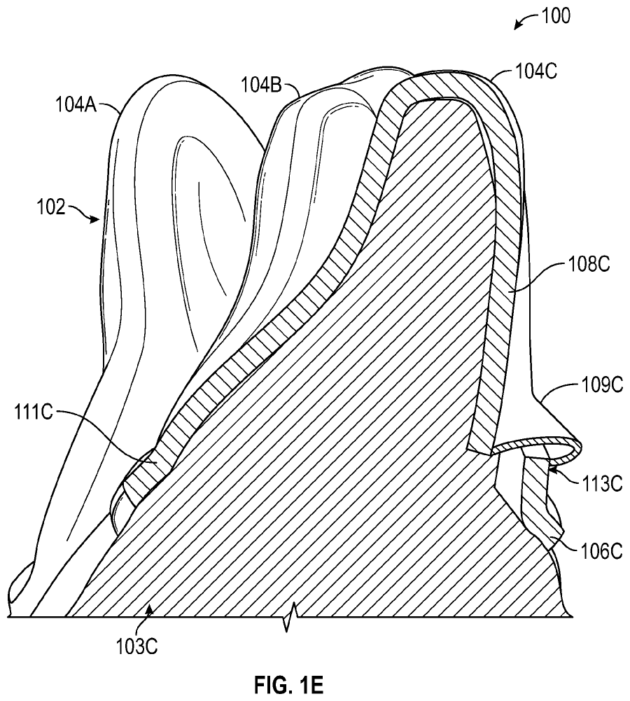

FIGS. 1A-1E illustrate facial, oblique facial, and mesial cross-sectional views of a portion of an example removable dental appliance 100 that includes a plurality of shells 104A-104D (collectively, “shells 104”), shell 104C including a flap 108C and bridge 109C configured to apply a force 107C to a tooth 103C of a patient. As depicted, the bridge 109C is an arcuate member, and will be identified as such in references to FIGS. 1A-1E. Removable dental appliance 100 includes appliance body 102 configured to at least partially surround plurality of teeth 103A-103D (collectively, “teeth 103”) of the mandibular arch 101 of a patient. Appliance body 102 includes shells 104. Shells 104 may be configured to receive teeth 103. The flap 108C and arcuate member 109C may be configured to apply force 107C to tooth 103C to cause a movement of tooth 103C toward a desired position of tooth 103C when removable dental appliance 100 is worn by the patient. The desired position may include an intermediate position between the initial position and the final position after orthodontic treatment.

In some examples, flap 108C and arcuate member 109C may be configured to apply force 107C to an attachment on tooth 103C to cause a movement of tooth 103C toward the desired position. The attachment may include a natural undercut, such as, for example, a cusp tip, a cervical contour, or the like, an artificial undercut, a protrusion, a knob, a handle, or the like. By applying a force 107C to tooth 103C via flap 108C and arcuate member 109C, removable dental appliance 100 may improve control of at least one of a force vector direction, magnitude, or expression length, to achieve at least one of a desired tooth movement that may not be possible without flap 108C and arcuate member 109C, a desired tooth movement over a shortened treatment time, a desired tooth movement with fewer progressions of removable dental appliances in a set of removable dental appliances, or the like, compared to other orthodontic treatments.

For purposes of illustration, only teeth 103, shells 104, and flap 108C are shown in FIGS. 1A-1E, although appliance body 102 may include any number of shells 104 configured to at least partially surround any number of teeth 103, any number of flaps 108, and/or any number of arcuate members 109. For example, the number of teeth 103 on dental arch 101 may be fourteen, less than fourteen (e.g., a patient having one or more extracted teeth), or more than fourteen (e.g., a patient having wisdom teeth or hyperdontia). The number of shells 104 may be fourteen, less than fourteen (e.g., at least one shell configured to surround more than one tooth), or more than fourteen teeth (e.g., more than one shell portions configured to surround one tooth). Additionally, or alternatively, appliance body 102 may include a plurality of flaps 108 on the same or difference shells 104. Additionally, or alternatively, one or more of each of flaps 108 may include one or more arcuate members 109.

Appliance body 102 is configured to at least partially surround teeth 103 of either the maxillary dental arch or, as shown in FIGS. 1A-1E, the mandibular dental arch 101 of a patient. For example, appliance body 102 may surround at least one of the facial, lingual, and occlusal surfaces of teeth 103, overlap a portion of the gingiva of the patient, or the like. In some examples, appliance body 102 may surround different portions of different teeth 103.

Appliance body 102 includes shells 104. In some examples, appliance body 102 may include a respective shell of shells 104 for each respective tooth of teeth 103. In other examples, appliance body 102 may include fewer shells than teeth 103, e.g., shells may receive more than one tooth or a number of teeth 103 may not be surrounded by appliance body 102. In other examples, appliance body 102 may include more shells 104 than teeth 103, e.g., two or more shells 104 may surround at least a portion of at least one tooth of teeth 103. Each respective shell of shells 104 may be shaped to receive at least one respective tooth of teeth 103. In some examples, shells 104 may surround the facial, lingual, and occlusal portions of teeth 103. In other examples, shells 104 may surround fewer portions of teeth 103, such as, only the facial and lingual portions, or only one of the facial or lingual portions of teeth 103. For example, shells 104A, 104B, 104C, and 104D may be shaped to surround the lingual, occlusal, and facial portions of tooth 103A, 103B, 103C, and 103D, respectively. In some examples, shells 104 may define a plurality of voids. For example, appliance body 102 may define a framework configured to contact teeth 103 in selected locations. The selected location may include, for example, portions of interproximal regions between adjacent teeth, portions of occlusal surfaces of teeth, or portions of gingival margins of teeth. The framework may include material concentrated in areas or along lines as needed to resist deformation caused by internal stresses. These internal stresses come as a result of both applied forces and reaction forces acting on appliance body 102, where the applied forces are generally the result of elastic deformation in bendable flaps 108 as they contact the teeth, and the reaction forces are generally the result of other parts of appliance body 102 (e.g., shells 104) contacting tooth surfaces opposite the applied forces and their respective contact points. Key benefits to using a framework may include, for example, reduced material, reduced material cost, reduced fabrication time, increased aesthetics, and increased salivary flow. Such a framework also has the potential to be more rigid than an appliance having constant thickness, provided that increased thickness is used in areas where lines of force are concentrated to cause increased stress in the appliance material. As such, areas of material experiencing lower or minimal stress are removed. This is essentially the process of Generative Design, although it is typically iterative to evaluate stresses and refine the design after successive iterations until diminishing returns are achieved (a threshold is reached) in terms of optimization toward a particular goal, such as maximum rigidity, minimum volume, or a combination thereof. In this way, shells 104 may define a plurality of voids to define a framework contacting at least a portion of at least one of a first interproximal region mesial a respective tooth, a second interproximal region distal the respective tooth, an occlusal surface of the respective tooth, or a gingival margin of the respective tooth.

In some examples, a respective shell may not include a flap (e.g., shells 104A, 104B, and 104D). In some examples, a respective shell may apply forces to respective received tooth by deformation of the respective shell. For example, when worn by the patient, shells 104A, 104B, and 104D may deform. The deformation may result in a restorative force as the respective shell moves toward an undeformed configuration. The restorative force may be transferred to the respective tooth via one or more points of contact between the respective shell and the respective tooth. In this way, removable dental appliance 100 may combine some shells 104 that include flaps with some shells 104 that deform to move teeth 103 to desired positions of teeth 103. In other examples, a respective shell may be configured to be sufficiently stiff so as not to deform. A respective shell that does not deform may provide anchorage for neighboring shells, such as, for example, shells that include a flap 108. The selection of which shells 104 include flaps 108 may depend on the forces to be exerted on respective teeth 103, the movements of respective teeth 103, or both. For example, when deformation of a respective shell 104 does not interfere with the forces to be exerted on neighboring teeth 103 or the movements of neighboring teeth 103, the respective shell 104 may not include a flap 108. Conversely, when deformation of a respective shell 104 does interfere with the forces to be exerted on neighboring teeth 103 or the movements of neighboring teeth 103, the respective shell 104 may include a flap 108 to reduce deformation of the respective shell 104.

In some examples, appliance body 102 may include one or more anchor shells configured to receive one or more anchor teeth. In some examples, anchor teeth may include one or more molar teeth, premolar teeth, or both. In other examples, anchor teeth may include one or more anterior teeth, or a combination of one or more anterior and posterior teeth. Anchor shells may be configured to allow appliance body 102 to deform to result in a force sufficient to move (e.g., force sufficient to cause alveolar bone remodeling) selected teeth without resulting in sufficient force to move the respective anchor teeth.

Shell 104C may be shaped to engage tooth 103C in an initial position of tooth 103C. To engage an initial position of tooth 103C, an internal surface of shell 104C may contact an at least one selected location, a selected surface area, or both of tooth 103C. For example, as shown in FIG. 1C, surface 111C of shell 104C may contact at least a portion of an occlusal surface and a lingual surface of tooth 103C in an initial position. The locations of contact, surface area of contact, or both may affect force 107C applied by bendable flap 108C to tooth 103C, the resulting movement of tooth 103C, or both.

Shell 104C may also be shaped to receive tooth 103C in a desired position of tooth 103C. The desired position of tooth 103C may be the position after force 107C has been exerted on tooth 103C to move tooth 103C to the extent possible in shell 104C. For example, surface 111C may define void 119C internal to shell 104C. As shown in FIG. 1C, void 119C includes a wedge-shaped void with a maximum depth near the gingival margin of tooth 103C that tapers to a minimum near axis of rotation 116C at the incisal edge of tooth 103C. The wedge shape of void 119C may be congruent with the path of tooth 103C as tooth 103C moves toward the desired position defined by surface 111C. Tooth 103C may move through void 119C toward the desired position until tooth 103C contacts surface 111C. In this way, surface 111C may prevent tooth 103C from moving beyond the desired position.

Removable dental appliance 100 includes at least one flap 108C. In general, any number of flaps may be positioned on any number of shells 104. The flap 108C may be integrally formed with shell 104C of appliance body 102 to extend from hinge 110C, making flap 108C a bendable flap in that flap 108C can bend about a hinge in the shell 104C. Hereinafter, a flap that is tethered to a shell at one or more bridges, hinge points, segments, or axes can be described as a bendable flap. Hinge 110C extends along an incisal edge of shell 104C in the mesio-distal direction. Generally, a respective bendable flap 108 may extend from a respective hinge 110 axis extending along any portion of a respective shell, in any direction. By selecting a length and an orientation of a respective hinge axis 110, removable dental appliance 100 may be configured to apply a respective force via a respective bendable flap 108 to any portion of a respective tooth.

As shown in FIGS. 1A-1E, bendable flap 108C extends from hinge axis 110C on a facial surface of appliance body 102 and is positioned on a facial side of removable dental appliance 100. Appliance body 102 defines a flap boundary region 113C extending from first end 114C around bendable flap 108C to second end 112C. Flap boundary region 113C may include an area of reduced shear and tensile stress compared to surrounding portions of appliance body 102. For example, at least a portion of flap boundary region 113C includes a bridge, here an arcuate member 109C.

The bridge 109C may increase the flexibility of appliance body 102 at flap boundary region 113C compared to the surrounding appliance body 102. As illustrated in FIGS. 1A-1E, the bridge 109C may include a spring bellows (e.g., a ribbon of material) extending around at least a portion of flap boundary region 113C and coupled to shell 104C and bendable flap 108C. In some examples, bridge 109C may include a plurality of spring bellows. In other examples, the bridge 109C may include one or more jumpers (e.g., a rod of material) defining an arc in a plane tangential to the surface of shell 104C or extending outside of the plane tangential to the surface of shell 104C and coupled to shell 104C and bendable flap 108C. Spring bellows and jumpers are exemplary arcuate members. In some examples, the bridge 109C may include any suitable combination of one or more spring bellows, one or more jumpers, or one or more shear reduction regions. The bridge 109C serves as at least one connection between the flap 108C and the shell 104C, along with hinge 110C. In other embodiments explored in more detail below, one or more bridges serve as the sole structures tethering a flap to a shell.

Bridge 109C may have an arcuate, sinusoidal, zig-zag, pulsing wave, spiral, helix, serpentine, or folded cross-section in a plane tangential to the surface of shell 104C and/or a plane perpendicular to the plane tangential to the surface of shell 104C. The position (e.g., relative to shell 104C and bendable flap 108C) and shape of bridge 109C may be selected to allow for cantilever motion of bendable flap 108C and application of a selected force 107C to tooth 103C via bendable flap 108C when removable dental appliance 100 is worn by the patient.

In some examples, bridge 109C may be made of the same material as shell 104C. For example, bridge 109C may be formed integrally with shell 104C. In some examples, bridge 109C may be formed by laser cutting portions of appliance body 102 to define the bridge members 109C. Additionally, or alternatively, bridge 109C may be formed by remolding (e.g., heating and applying a force) portions of appliance body 102, or coupling additional material to a surface of appliance body 102 (e.g., by adhesion, thermo welding, ultrasonic welding, or the like). In some examples, at least a portion of bridge 109C may be thinner than shell 104C to allow for greater flexibility, for example, of the spring bellows or the jumper. In some examples, at least a portion of bridge 109C may be thicker than shell 104C to allow for greater rigidity or toughness of the spring bellows or the jumper. In some examples, the bridge 109C may include different or additional material, such as materials having a higher modulus relative to the material of appliance body 102, metals (wires, ribbons, or sheets), or the like. The materials and manufacture of the bridge 109C may be selected to allow for cantilever motion of bendable flap 108C and application of a selected force 107C to tooth 103C via bendable flap 108C when removable dental appliance 100 is worn by the patient.

In examples in which bridge 109C includes one or more spring bellows, the spring bellows may include a continuous or discontinuous curvilinear portion of appliance body 102, e.g., an arc, a half wave, a full wave shape, zig-zag, sinusoid, a pulsed wave, or serpentine shape. In some examples, the arcuate displacement may include at least one fold to increase the length and/or flexibility of the spring bellows. The length of the spring bellows may be selected to provide a selected force resulting from the deformation of the spring bellows when removable dental appliance 100 is worn by the patient.

In examples in which the spring bellows includes a continuous curve, the arcuate displacement may define an outer radius of curvature, e.g., an outermost surface of the spring bellows. In some examples, the outer radius of curvature may be between about 0.5 millimeters and about 3 millimeters, or about 0.75 millimeters and about 1.5 millimeters, or about 1.0 millimeters. The radius of curvature may be substantially constant or may vary along an interproximal boundary curve. The spring bellows also may define a displacement distance extending between a midline of flap boundary region 113C and a midline of the spring bellows. In some examples, the displacement distance may be less than about 3 millimeters, or less than about 1 millimeter, or less than about 0.75 millimeters, or about 0.5 millimeters. The displacement distance may be substantially constant or may vary along flap boundary region 113C.

A thickness of the spring bellows may be less than a thickness of shell 104C and bendable flap 108C such that the spring bellows deforms more than shell 104C and bendable flap 108C to concentrate compression, tension, shear, bending, or torsion in the spring bellows. The thickness of the spring bellows may be between about 0.025 millimeters and about 1.0 millimeter, or between about 0.1 millimeters and about 0.75 millimeters, or between about 0.15 and about 0.6 millimeters, or about 0.3 millimeters. The thickness of the spring bellows may be substantially constant or vary along flap boundary region 113C.

In some examples, the spring bellows may define at least one shear reduction region, e.g., at least one void or cutout in the spring bellows. The at least one shear reduction region may concentrate deformation of the spring bellows in selected portions of the spring bellows. The location of the terminations of the spring bellows on the shell 104C and bendable flap 108C may be selected to provide a selected direction and magnitude of force when removable dental appliance 100 is worn by the patient. In some examples, bridge 109C may include a plurality of spring bellows, each respective spring bellows of the plurality of spring bellows disposed along a respective portion of the flap boundary region.

By selecting the shape, length, radius of curvature, and displacement distance of spring bellows, removable dental appliance 100 may control at least one of a direction, a magnitude, and a length of expression of a force on bendable flap 108 resulting from deformation of appliance body 102 when removable dental appliance 100 is worn by the patient. Other spring bellows configurations are described in International Publication No. WO/2019/069162 (Raby, et al.), which is incorporated herein by reference in its entirety.

In examples in which the bridge 109C includes a jumper, the jumpers include an elongate structure extending along a longitudinal axis between a first end coupled to any suitable portion of shell 104C or a different shell 104 (e.g., not directly adjacent to bendable flap 108C) and a second end coupled to any suitable portion of bendable flap 108C. At least a portion of force 107C results from a deformation of the jumper when removable dental appliance 100 is worn by the patient. For example, when removable dental appliance 100 is worn by the patient, the jumpers may deform to exert at least one of a bending force, a twisting force, a compressive force, a tensile force, or a shear force on the first end and the second end such that selection of the location of the first and second ends may control the direction and magnitude of force 107C.

The jumper may include any suitable shape along the longitudinal axis of the elongate structure, such as, for example, at least one of an arc, fold, zig-zag, sinusoid, spiral, helix, or serpentine shape extending between the first end and the second end of the jumper. In some examples, elongated structure may include at least one fold. In some examples, a medial portion of the jumper (e.g., between the first end and second end) may extend away from a plane tangential to a surface of shell 104C. In other examples, the medial portion of the jumper may be substantially in the plane tangential to a surface of shell 104C (e.g., deviate from the plane by less than about 0.5 mm).

In some examples, the jumper may include an arcuate shape having an outer radius of curvature (e.g., outermost surface of the jumper) between about 0.5 millimeters and about 5 millimeters. In some examples, the jumper may include a displacement distance (e.g., distance between a plane tangential to a surface of shell 104C and a midline of the inner radius of the jumper) less than about 2 millimeters, or less than about 1 millimeter, or less than about 0.5 millimeters, or about 0.5 millimeters. The jumper may define a cross-section in a plane perpendicular to a longitudinal axis of the elongated structure having any suitable shape, area, or aspect ratio selected to provide a selected force to bendable flap 108C. The shape, area, or aspect ratio of the cross-section may be constant or vary along the longitudinal axis.

The jumper may include any suitable thickness selected to control the magnitude and direction, or the location of concentration, of force 107C resulting from deformation of appliance body 102 when removable dental appliance 100 is worn by the patient. In some examples, the jumper may be more flexible than the shell to at least one of reduce deformation of the shell or concentrate stress in the jumper when the removable dental appliance is worn by the patient. In some examples, a thickness of appliance body 102 increases near at least one of the first end or the second end of the jumper, for example, to improve toughness of the intersection of the first and second ends and appliance body 102. A thickness of the jumper may be substantially constant or may vary along the elongated structure in a tapered or stepwise manner. In some examples, the thickness of the jumpers may be between about 0.1 millimeters and about 3.0 millimeters, or about 0.3 millimeters and about 1.0 millimeter.

In some examples, the appliance body may include a gingival portion coupled to the second end of the jumper (the first end being coupled to bendable flap 108C) to at least partially anchor appliance body 102 to the alveolar process via the gingiva. In some examples, the bridge 109C may include a plurality of jumpers, each respective jumper of the plurality of jumpers including a respective elongated structure extending between a respective first end coupled to a respective position on the shell and a respective second end coupled to a respective position on the bendable flap.

By selecting the shape, length, radius of curvature, and displacement distance of jumpers, removable dental appliance 100 may control at least one of a direction, a magnitude, and a length of expression of a force on bendable flap 108 resulting from deformation of appliance body 102 when removable dental appliance 100 is worn by the patient. Other jumper configurations are described in International Publication No. WO/2019/069164 (Raby, et al.), which is incorporated herein by reference in its entirety.

In some examples, the bridge 109C may result in at least a portion of force 107C, bendable flap 108C may remain relatively unbent in the deformed portion, or both. Bridge 109C may at least one of enable increased surface contact of bendable flap 108C with tooth 103C, reduce build-up of food particles or plaque in flap boundary region 113C or other portions of the appliance body 102, and reduce conflict between the bendable flap 108C and the dental anatomy of the patient, when removable dental appliance 100 is worn by the patient or fitted to the teeth.

In some examples, shell 104C may be thinner or include one or more voids along hinge axis 110C. The thinner material or voids along hinge 110C may relieve bending stresses in bendable flap 108C. In some examples, at least a portion of flap boundary region 113C also may define one or more cutouts or slits in appliance body 102. Removal of the material from flap boundary region 113C may effectively nullify shear and tensile stress in flap boundary region 113C. Additionally or alternatively, at least a portion of flap boundary region 113C may include an elastomeric polymer or material with a lower elastic modulus than appliance body 102, an area of reduced thickness of appliance body 102, or the like, to increase the flexibility of flap boundary region 113C compared to the surrounding appliance body 102. In this way, flap boundary region 113C may allow bendable flap 108C to deflect in the lingual-facial direction, reduce the amount of deformation in bendable flap 108C to increase contact area of the number of contacts between bendable flap 108C and tooth 103C, or both to improve control over tooth movement. In examples in which flap boundary region 113C includes an elastomeric material, the elastomeric material may be selected to allow bendable flap 108C to deflect in the facial-lingual direction, cover at least a portion of flap boundary region 113C to reduce build-up of food particles or plaque in flap boundary region 113C or other portions of the appliance body 102, or both.

Bendable flap 108C, bridge 109C, and optionally hinge 110C may be configured to apply force 107C to a facial surface of tooth 103C. For example, a rest position of bendable flap 108C may intrude into a space defined by tooth 103C in a desired position of tooth 103C such that when removable dental appliance 100 is worn by the patient, an initial position of tooth 103C may cause a deformation of bendable flap 108C and bridge 109C. The deformation of bendable flap 108C and bridge 109C may result in force 107C, e.g., a restorative force as bendable flap 108C and bridge 109C move toward an undeformed configuration. The rest position of bendable flap 108C and the bridge 109C may be selected to reduce conflict with the incisal edge of tooth 103C when removable dental appliance 100 is fitted to the teeth. Additionally, or alternatively, bendable flap 108C may include a ramped surface near a gingival portion of bendable flap 108C such that the ramped surface deflects bendable flap 108C and the bridge 109C or otherwise reduces conflict with the incisal edge of tooth 103C when removable dental appliance 100 is fitted to the teeth.

In response to force 107C, tooth 103C may move through void 119C toward the desired position until tooth 103C contacts surface 111C. In some examples, if only a portion of tooth 103C contacts surface 111C, while gaps remain elsewhere, a couple may be formed between the contact point and force 107C. The resulting couple may cause tooth 103C to move, e.g., to “walk,” into a position of greater alignment with surface 111C. For example, tooth 103C may move in stages of alternating translation and rotation, until tooth 103C is received in a position of substantial conformity with surface 111C. In some examples, surface 111C may be positioned beyond the desired position of tooth 103C to compensate for relapse of tooth 103C back toward an intermediate position or the initial position of tooth 103C. In this way, selecting the shape of internal surface of shell 104C may enable control of the locations of a force and resulting movement of tooth 103C. Similar effects are also possible for shells 104A, 104B, and 104D.

Force 107C may be transferred from flap 108C and bridge 109C to tooth 103C by one or more contact points of flap 108C with tooth 103C. For example, an interior surface of the flap 108C may contact at least a portion tooth 103C. In some examples, the interior surface of flap 108C may be shaped to conform to a shape of tooth 103C in a desired position of tooth 103C such that contact between bendable flap 108C and tooth 103C is increased as tooth 103C moves toward the desired position. In some examples, the thickness of flap 108C may be selected to control the number or location of contact points. In some examples, the flap 108C may be divided (e.g., by laser cutting) into a plurality of flaps to control the number or location of contact points. In other examples, flap 108C may include at least one protrusion on an interior surface of bendable flap 108C. The protrusion may be positioned or shaped to transfer force 107C to at least one selected portion of tooth 103C. For example, flap 108C may include at least one protrusion near the gingival portion of the flap 108C such that the transfer of force 107C to tooth 103C is concentrated near the gingival margin. By concentrating the transfer of force near the gingival margin, the flap 108C may more effectively cause a torqueing or root tipping of tooth 103C. In this way, protrusions on respective flaps may be used to control the transfer of a respective force to achieve or increase the effectiveness of tooth movements, such as, for example, translation, rotation, tipping, torqueing, extrusion, intrusion, or combinations thereof.

In some examples, as shown in FIG. 1C, when removable dental appliance 100 is worn by the patient, axis of rotation 116C may be substantially fixed or anchored through appliance body 102 to other parts of the dental anatomy, such as, for example, teeth 103A, 103B, and 103D. Application of force 107C to a portion of tooth 103C near the gingival margin by flap 108C and bridge 109C may form a couple with axis of rotation 116C. A couple may include two opposing forces offset by some distance. For example, as force 107C moves tooth 103C with a center of resistance located near the center of the root of tooth 103C, the fixed axis of rotation 116C of shell 104C may apply a second opposing force to the incisal edge of tooth 103C. By forming a couple with axis of rotation 116C, force 107C may result in rotation 118C of tooth 103C toward void 119C, e.g., a root tipping or torqueing movement. In this way, the locations of contact, surface area of contact, or both of surface 111C of shell 104C may affect force 107C applied to tooth 103C, the resulting movement of tooth 103C, or both.

When removable dental appliance 100 is fitted to, or removed from, teeth 103, the flap 108C and bridge 109C may deflect in the lingual-facial direction as flap 108C and bridge 109C deforms to accommodate tooth 103C. The deflection may cause stress near first and second ends 114C and 112C of hinge 110C, and/or where the bridge 109C is coupled to shell 104C and flap 108C. To reduce stress caused by deflection of flap 108C and/or bridge 109C, appliance body 102 may define stress concentration reduction regions. The circular stress concentration reduction regions may include a diameter that is at least greater than a width of flap boundary region 113C. As flap 108C and bridge 109C deflect, stress may be distributed around the circular stress concentration reduction region to reduce localized concentration of stress that may otherwise tear appliance body 102 or cause wearing of appliance body 102. Reducing localized concentration of stress may reduce wear on appliance body 102 and increase the useable life of removable dental appliance 100.

By allowing deflection of the flap 108C in the lingual-facial direction, the flap 108C and bridge 109C may be configured to apply force 107C to a side of tooth 103C opposite from void 119C to cause movement of tooth 103C toward void 119C. For example, the flap 108C may be configured to intrude into a space defined by the desired position of tooth 103C when the flap 108C is in a rest position. In some examples, the desired position of tooth 103C is a position after tooth 103C contacts at least a portion of the surface of appliance body 102 defining void 119C internal to shell 104C. As shown in FIG. 1E, the flap 108C intrudes into the space defined by tooth 103C. By intruding into the space defined by tooth 103C in the desired position, the flap 108C and bridge 109C may apply force 107C to tooth 103C through the movement of tooth 103C into void 119C. For example, as illustrated in FIG. 1C, the flap 108C and the bridge 109C may apply force 107C to tooth 103C when tooth 103C is in an initial position. As seen in FIG. 1D, the flap 108C and bridge 109C applies force 107C to tooth 103C when tooth 103C is in the desired position. When tooth 103C is in the desired position, force 107C may be greater than a minimum force to cause alveolar bone remodeling. In this way, removable dental appliance 100 may achieve complete expression of tooth 103C through void 119C to a position of substantial conformity with surface 111.

In some examples, appliance body 102 may include gingival regions 106A, 106B, 106C, and 106D (collectively, “gingival regions 106”) that overlap at least a portion of the gingiva (e.g., gingival margins) of the patient. For example, gingival regions may extend around the gingival portion of shells 104, where teeth 103 meets the gingiva. Gingival regions 106 may be configured to use at least a portion of the gingiva, the alveolar process, or both for anchorage. For example, when worn by the patient, gingival regions 106 may at least partially contact the gingiva to access additional bracing provided by gingival regions 106 indirectly engaging with the alveolar process without impeding mobility of teeth 103. Additionally, or alternatively, by increasing an extent of shells 104 with gingival regions 106, greater force may be applied to a selected tooth of teeth 103 while using the more rigid alveolar process as an anchor instead of neighboring teeth. As such, gingival regions 106 may allow better control of tooth movements relative to a fixed reference (the alveolar process), without causing unwanted reactionary movements of neighboring teeth. In some examples, appliance body 102 may exclude gingival regions 106.

In some examples, appliance body 102 may include a unitary material, e.g., a single, uniform material. The unitary material may include a single polymer, or homogeneous mixture of one or more polymers. For example, removable dental appliance 100 may consist of a single, continuous 3D printed or thermoformed component. In other examples, appliance body 102 may include a multi-layer material. Multi-layer materials may enable one or more portions of appliance body 102 to be formed with a plurality of layers having different elastic modulus to enable selection of force characteristics, displacement characteristics, or both of bendable flap 108C. The multi-layer material may include multiple layers of a single material, e.g., a single polymer, or multiple layers of a plurality of materials, e.g., two or more polymers, a polymer and another material. For example, removable dental appliance 100 may consist of a multilayer 3D printed or thermoformed component. Suitable polymers may include, but are not limited to, (meth)acrylate polymer; epoxy; silicones; polyesters; polyurethanes; polycarbonate; thiol-ene polymers; acrylate polymers such as urethane (meth)acrylate polymers, polyalkylene oxide di(meth)acrylate, alkane diol di(meth)acrylate, aliphatic (meth)acrylates, silicone (meth)acrylate; polyethylene terephthalate based polymers such as polyethylene terephthalate glycol (PETG); polypropylene; ethylene-vinyl acetate; or the like. The thickness of appliance body 102 may range between about 0.10 millimeters and about 2.0 millimeters, such as between about 0.2 and about 1.0 millimeters, or between about 0.3 millimeters and about 0.75 millimeters. In the same or different examples, removable dental appliance 100 may include chamfers or fillets on edges of appliance body 102 and other spaces. Such chamfers or fillets may improve patient comfort and reduce the visibility of removable dental appliance 100. In the same or different examples, removable dental appliance 100 may include at least one reinforcement structure to increase the stiffness of an area of appliance body 102 (e.g., bendable flap 108C or arcuate member 109C) to increase the strength of an area of appliance body 102 (e.g., hinge axis 110C).

In some examples, removable dental appliance 100 may include metallic components configured to enhance forces applied by removable dental appliance 100 to one or more of the surrounded teeth. For example, the metallic component may comprise a metal wire having any suitable cross sectional shape (e.g., circular, rectilinear, or a ribbon) extending through at least a portion of appliance body 102, such as bendable flap 108C or arcuate member 109C. In some examples, removable dental appliance 100 may include one or more other metal components, such as metal occlusal components, where greater durability is needed to overcome the stress of high-pressure occlusal contact, such as caused by bruxing, or mastication. In some examples, removable dental appliance 100 may include catches to connect to an anchorage device implanted within the patient, e.g., a temporary anchorage device or mini-screw. For example, catches may be positioned on anchor shells to connect to an anchorage device on anchor teeth. In this manner, such removable dental appliances 100 may provide a hybrid construction of metal and plastic. While plastic components may be generally clear for reduced visibility, metal components may include plating or other coloring to reduce visibility of removable dental appliance 100 when worn by the patient. For example, metal components positioned near teeth 103 of a patient when worn may include white colored coating or plating, such as, for example, rhodium, silver, white anodized titanium, Teflon, PTFE, and the like, or be formed of a white colored metal, such as, for example, rhodium, silver, white anodized titanium, and the like. Metal components positioned elsewhere may be colored to generally match tissue color within the mouth of the patient.

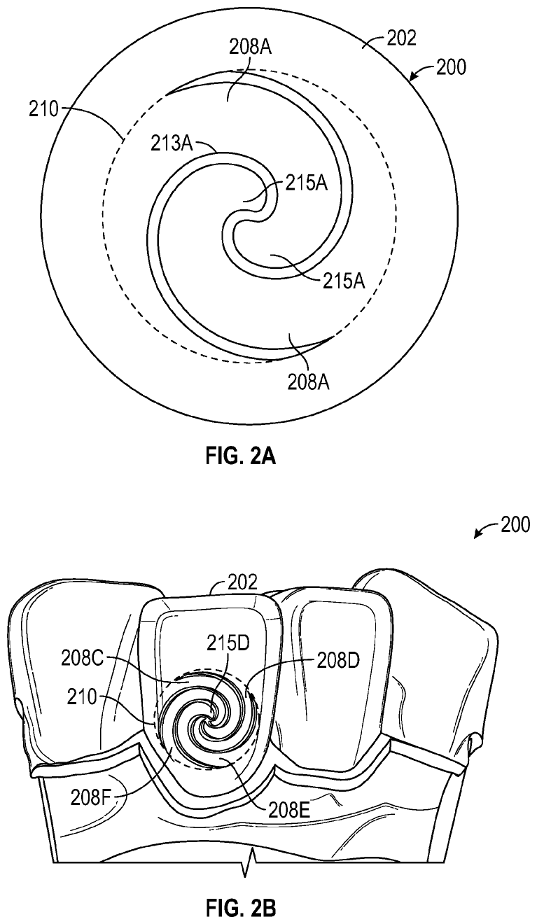

In some examples, a respective flap or plurality of flaps may define a spiral configuration. FIGS. 2A-2B are conceptual diagrams illustrating an example removable dental appliance 200 that includes flaps 208 having a spiral configuration. Removable dental appliance 200 may be the same as or substantially similar to removable dental appliance 100 discussed above in reference to FIGS. 1A-1E, except for the differences describe herein.

The spiral configuration of the flaps 208 may enable a flap (or a plurality of flaps) to apply a force near a center of the spiral and distribute a corresponding deformation around a perimeter of the spiral. In these and other embodiments not depicted, any number of flaps may be arranged in a spiral configuration to increase the effective length of the resulting cantilever arm(s). For example, as illustrated in FIG. 2A, appliance body 202 may include two flaps 208A defining a single flap boundary region 213A defining a double spiral configuration. When in a rest position, centers 215A of flaps 208A may intrude into a space defined by a desired position of a tooth. In a deformed position, when worn by a patient, flaps 208A may deform to concentrate a deformation force on the tooth near centers 215A. The deformation force of flaps 208A may be transferred to appliance body 202 around a perimeter 210 of the spiral configuration. In some examples, as illustrated in FIG. 2B, the spiral configuration may include a quadruple spiral configuration having a plurality of bendable flaps 208C, 208D, 208E, 208F. In some examples, removable dental appliance 200 may include bridges as discussed above in reference to FIGS. 1A-1E.

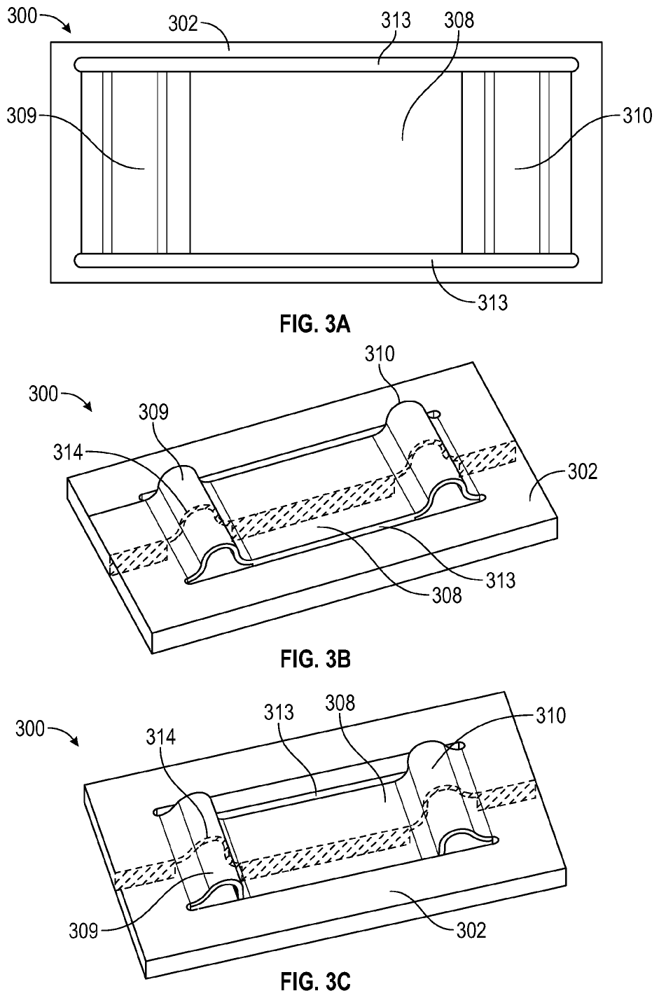

In some examples, a respective flap may lack a hinged connection to the appliance body and may be tethered by one or more bridges. FIGS. 3A-3C are conceptual diagrams illustrating an example removable dental appliance 300 that includes a flap 308 coupled to the body 302 by a pair of a spring bellows 309, 310 (i.e., bridges). Removable dental appliance 300 may be the same as or substantially similar to removable dental appliance 100 discussed above in reference to FIGS. 1A-1E, except for the differences described herein.

As illustrated in FIGS. 3A-3C, flap 308 is moveable relative to the appliance body 302 in direction toward a tooth surface (see e.g., FIG. 3C). Flap 308 is accordingly a bendable flap. Bendable flap 308 defines slotted sides 313. Slotted sides 313 may include apertures extending through appliance body 302. In other examples, slotted sides 313 may include any suitable type of area of reduced shear resistance compared to adjacent portions of appliance body 302. Appliance body 302 includes a pair of bridges 309, 310 presented on opposing ends of the flap 308. As illustrated in FIG. 3B, the bridges 309, 310 may define a displacement of appliance body 302 away from a plane tangent to the surface of bendable flap 308. As illustrated in the cross-sectional views of FIGS. 3B & 3C, a thickness 314 of at least one of the bridges 309, 310 may be substantially less than a thickness of other portions of appliance body 302, including the flap 308 and the shell (not shown). In some examples, the bridges 309, 310 may each act as a spring and store potential energy. By combining the bending moments of bendable flap 308, and/or bridges 309, 310, the total bending moments may closely approximate those about a horizontal line of approximately 10N more than any of bendable flap 308, and/or bridges 309, 310 could achieve independently. In some examples, bendable flap 308, and/or bridges 309, 310 may be simpler and easier to engineer and manufacture compared to, for example, a continuous spring bellows surrounding a U-shaped bendable flap. For example, it may be easier to model and compute the forces in bendable flap 308, and/or bridges 309, 310 compared to, for example, a continuous spring bellows surrounding a U-shaped bendable flap. Such simplified modeling may reduce computational intensity or time when determining positions, dimensions, and shapes of flaps and arcuate member to provide selected forces to teeth to achieve a selected treatment plan. Additionally, or alternatively, bendable flap 308, and/or bridges 309, 310 may be simpler to machine because only linear cut paths may be needed. In some examples, bendable flap 308, and/or bridges 309, 310 may be mass produced as premanufactured parts and attached later to a formed appliance body 302. In such example, bendable flap 308, and/or bridge 309, 310 may be formed using continuous linear extrusion of material and cutting bendable flap 308, and/or bridges 309, 310 into individual parts of any given width. In some examples, at least a portion of appliance body 302 adjacent bendable flap 308 may define voids (e.g., slots 313 may be enlarged). In some examples, by not transferring force directly to appliance body 302 adjacent bendable flap 308 deformation of appliance body 308 may be reduced when such a concern is realized or in example where the close proximity of neighboring structures might be such that appliance body 302 fit to the teeth may be compromised due to such deformation.

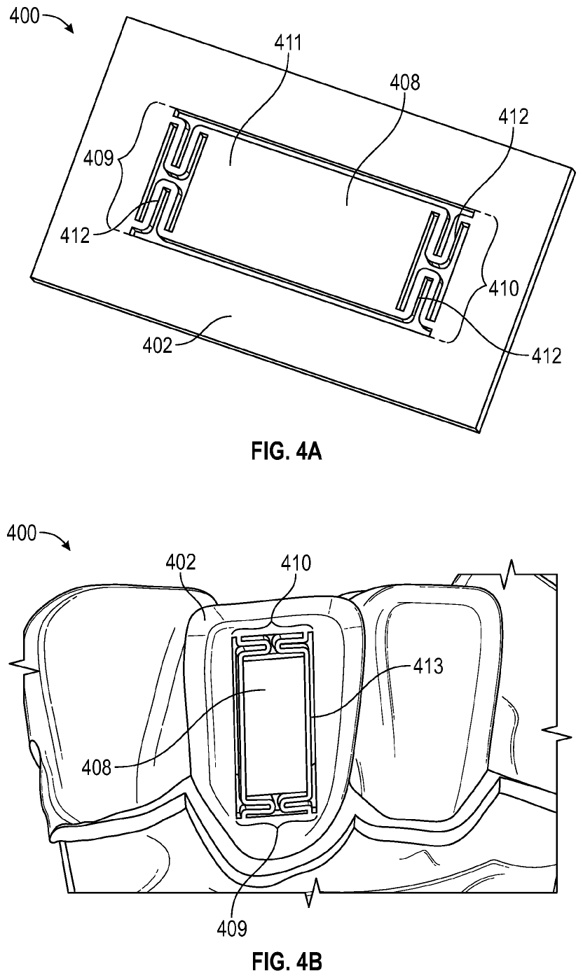

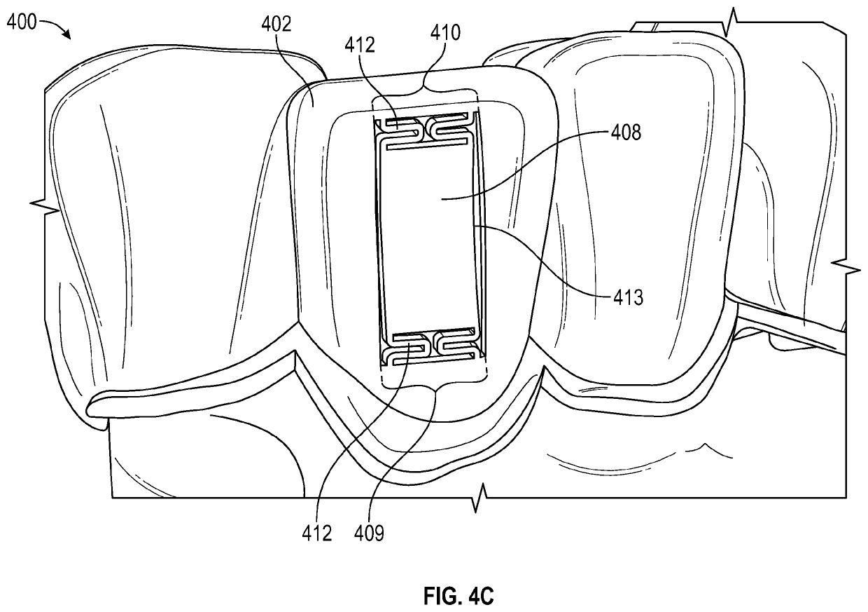

In some examples, an appliance body may include a flap tethered to the appliance body 402 by a pair of bridges 409, 410 that includes zigzag springs in a plane tangential to a surface of the appliance body. FIGS. 4A-4C are conceptual diagrams illustrating an example removable dental appliance 400 that includes a flap 408 and bridges 409, 410 in a plane tangential to a surface of appliance body 402. Like flap 108, flap 408 is a bendable flap. Removable dental appliance 400 may be the same as or substantially similar to removable dental appliances 100 discussed above in reference to FIGS. 1A-1E, except for the differences describe herein.

As illustrated in FIGS. 4A-4C, bendable flap 408 is tethered by bridges 409, 410 on opposing sides of the flap 408 body. Bendable flap 408 further defines slotted sides 413. Slotted sides 413 may include apertures extending through appliance body 402. In other examples, slotted sides 413 may include any suitable type of area of reduced shear resistance compared to adjacent portions of appliance body 402. The bridges 409, 410 include zigzag shaped springs 412 in a plane tangential to a surface of appliance body 402. In some examples, arcuate bridges 409, 410 may enable bendable flap 408 to move in a direction perpendicular to the plane tangential to a surface 411 of the flap and in a lingual-labial direction (see e.g., FIG. 4C). The movement of bendable flap 408 may, in some examples, improve expression during movement of a respective tooth. In some examples, the configuration illustrated in FIGS. 4A-4C may be effective at isolating the shell 404 from reaction forces. In some examples, bendable flap 408, and/or bridges 409, 410 may be simpler to machine because an end mill or laser cutter may be used to cut the features into appliance body 402 after thermoforming appliance body 402. As such, the configuration illustrated in FIGS. 4A-4C may be suited to design constraints and methods of manufacture that call for an appliance of substantially constant thickness. In some examples, by removing material along the zig-zag spring, deformation of bendable flap 408 may be reduced to increase contact area with a tooth or allow for more predictable contact points. In some examples, the configuration illustrated in FIGS. 4A-4C may be more comfortable for the patient by protruding less into the direction of the tongue, lips, or cheeks. Many variations of the bridges 409, 410 are possible, such as, for example, one or more jumpers or variation in the amplitude, width, length, attachment points, or the like of the one or more jumpers.

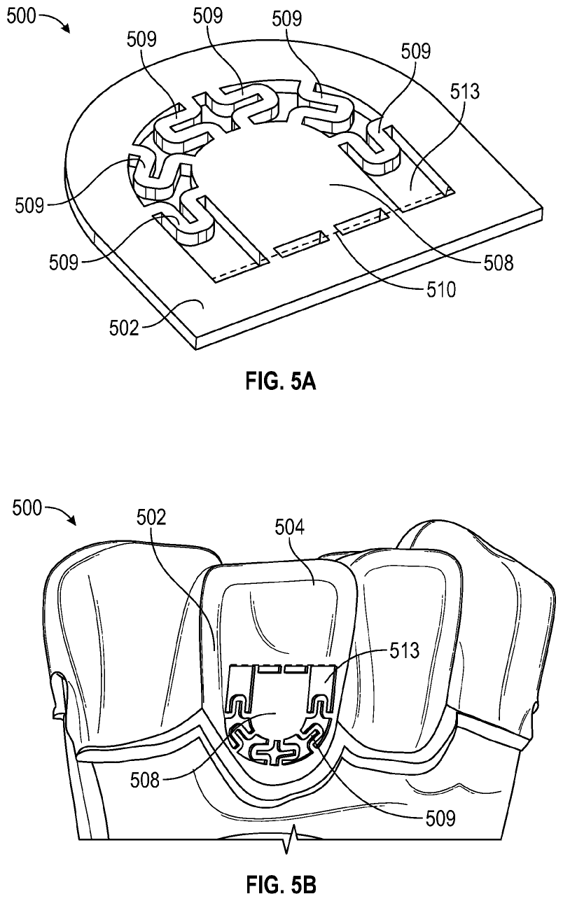

In some examples, an appliance body may include a flap and a plurality of bridges extending over a flap boundary region. FIGS. 5A and 5B are conceptual diagrams illustrating an example removable dental appliance 500 that includes a flap 508 extending from a slotted hinge axis 510 and a plurality of jumpers 509 bridging flap boundary region 513 in a plane tangential to a surface of appliance body 502 opposite hinge axis 510. Like flaps 308 and 408, flap 508 is a bendable flap. Removable dental appliance 500 may be the same as or substantially similar to removable dental appliances 100 discussed above in reference to FIGS. 1A-1E, except for the differences describe herein.

As illustrated in FIGS. 5A and 5B, bendable flap 508 extends from appliance body 502 at slotted hinge 510. Bendable flap 508 defines flap boundary region 513. Appliance body 502 includes a plurality of bridges 509 extending from shell 504 to bendable flap 508. Although six bridges 509 are illustrated, in other examples, appliance body 503 may include fewer or more bridges 509. Bridges 509 include a plurality of zigzag shaped springs in a plane tangential to a surface of appliance body 502. In some examples, bridges 509 may enable bendable flap 508 to move in the plane tangential to a surface of appliance body 502 and in a lingual-labial direction. The movement of bendable flap 508 may, in some examples, improve expression during movement of a respective tooth. Additionally, or alternately, the plurality of bridges 509 may improve control of the direction or magnitude of a force applied by bendable flap 508 to a surface of a tooth. The configuration illustrated in FIGS. 5A and 5B may enable increased force compared to other configuration by placing additional bridges 509 along the sides of bendable flap 508. In some examples, bridges 509 may be omitted from the distal end of bendable flap 508 (e.g., the end most distant from the hinge axis) to allow bendable flap 508 to be positioned more closely to neighboring dental structures or force actuators. In some examples, the configuration illustrated in FIGS. 5A and 5B may allow for a more flexible bendable flap 508 by decreasing the number of bridges 509 and increasing the length of one or more of the bridges 509. This is made possible by the increased length available when utilizing flap boundary region 513 on the lateral sides of bendable flap 508 in addition to the region at the distal end of bendable flap 508.

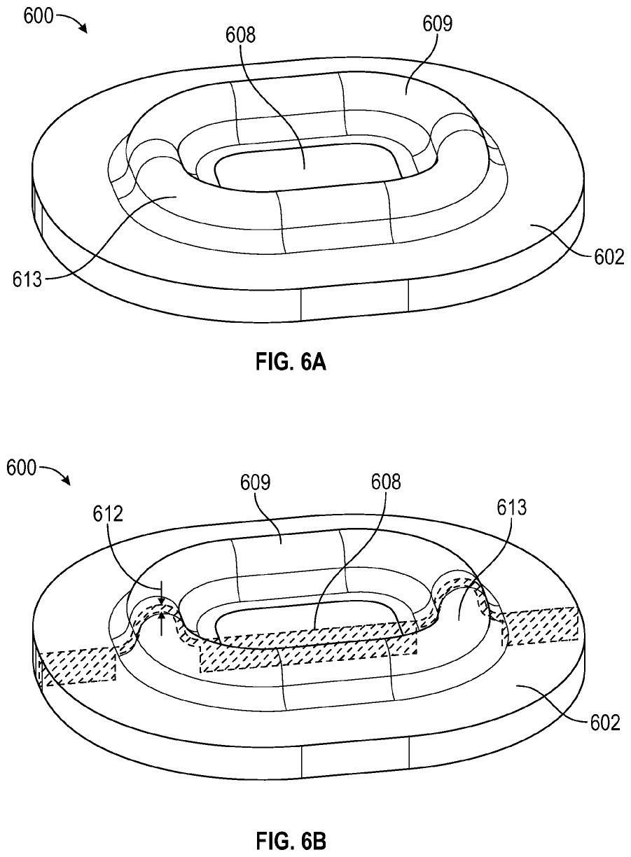

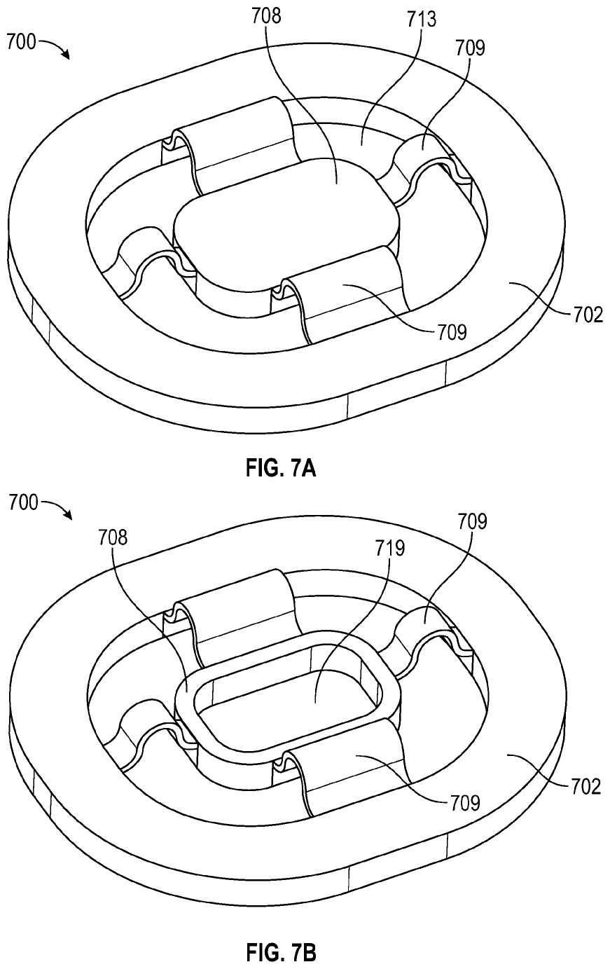

In some examples, an appliance body may include a flap and an arcuate member defining a spring bellows bridging at least a portion of a flap boundary region. FIGS. 6A and 6B are conceptual diagrams illustrating an example removable dental appliance 600 that includes a flap 608 and a spring bellows 609 extending around an entire flap boundary region 613. Like flaps 108, 208, 308, 408, and 508, flap 608 is a bendable flap. Removable dental appliance 600 may be the same as or substantially similar to removable dental appliance 100 discussed above in reference to FIGS. 1A-1E, except for the differences describe herein.

As illustrated in FIGS. 6A and 6B, an appliance body 602 includes a bridge 609 extending around an entire flap boundary region 613. As illustrated in FIGS. 6A and 6B, bridge 609 may define a displacement of appliance body 602 away from a plane tangential to the surface of bendable flap 608. As illustrated in the cross-sectional view of FIG. 6B, a thickness of bridge 609 may be substantially less than a thickness 612 of other portions of appliance body 602, including bendable flap 608 and/or the shell. The relatively thinner bridge 609 may be more flexible than the surrounding appliance body 602 or bendable flap 608. Additionally, or alternatively, in some examples, one or more portions of bridge 609 may include slots to reduce shear stress in selected regions. As illustrated in FIG. 6B, bridge 609 may include a continuous spring bellows. The continuous spring bellows may protrude further from the plane around flap boundary region 613. In some examples, bridge 609 may include a plurality of undulations toward and away from the plane tangential to a surface of appliance body 602. Such undulation may improve control of a direction and/or magnitude of force applied by bridge 609 to bendable flap 608. The configuration illustrated in FIGS. 6A and 6B may increase patient comfort by eliminating exposed edges of appliance material, provide substantially greater forces than other examples by increasing the effective length of the spring bellows to include the lateral sides of the flap, and/or reduce buildup of food and plaque, compared to appliance bodies having voids defining arcuate members. In some examples, appliance body 602 may include fillets or chamfers to improve patient comfort and/or reduce buildup of food or plaque in corners or inside edges of appliance body 602. In some examples, appliance body 602 may be thermoformed without the need for post-processing, such as machining or cutting. In some examples, appliance body 602 may be 3D printable without the need for support structures on or near bendable flap 608, depending on appliance orientation in the printer (because of the elimination of exposed edges that might lack localized support).

In some examples, an appliance body may include a flap and a plurality of bridges defining jumpers bridging at least a portion of a flap boundary region. FIGS. 7A and 7B are conceptual diagrams illustrating an example removable dental appliance 700 that includes a bendable flap 708 and a plurality of jumpers 709 bridging flap boundary region 713. Removable dental appliance 700 may be the same as or substantially similar to removable dental appliance 100 discussed above in reference to FIGS. 1A-1E, except for the differences describe herein.

As illustrated in FIGS. 7A and 7B, appliance body 702 includes jumpers 709 bridging flap boundary region 713 to tether a flap 708 to the body 702. As illustrated in FIGS. 7A and 7B, jumpers 709 may define a displacement of appliance body 702 away from a plane tangential to the flap 708. Although four jumpers 709 are illustrated, in other examples, appliance body 702 may include fewer or more jumpers 709. The thickness of jumpers 709 may be substantially less than a thickness of other portions of appliance body 702, including bendable flap 708 and shell (not shown). The relatively thinner jumpers 709 may be more flexible than the surrounding appliance body 702 or bendable flap 708. Additionally, or alternatively, in some examples, one or more portions of jumpers 709 may include slots to reduce shear stress in selection regions. In some examples, the force may be lessened by interrupting the continuity of jumpers 709 with discrete through holes or shear reduction areas, thus reducing the total area of jumpers 709 without reducing thickness to the point of compromised durability, formability, printability, or the like. Jumpers 709 can also be placed on the lateral sides only of bendable flap 708 to reduce aspect ratio or length overall of bendable flap 708. In some examples, the voids defined by appliance body 702 (e.g., jumpers 709) may increase salivary flow around the teeth and through the appliance, which can be beneficial toward the flushing out of acid which can, given prolonged contact with the teeth, lead to demineralization of tooth enamel, white spot lesions, dental caries, gingivitis, or the like. The bendable flap 708 may further include an open region 719 at the center of the flap, leading the flap 708 to resemble a ring or donut as depicted in FIG. 7B.

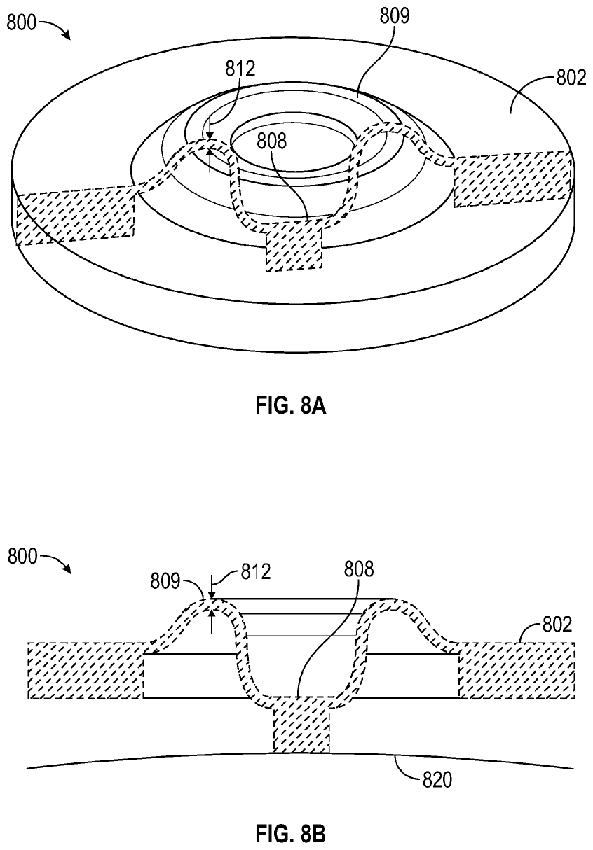

In some examples, an appliance body may include a flap and an arcuate member defining a spring bellows bridging at least a portion of a flap boundary region. FIGS. 8A and 8B are conceptual diagrams illustrating an example removable dental appliance 800 that includes a flap 808 and a spring bellows 809 extending around an entire flap boundary region 813. Like flaps 208, 308, 408, 508, 608, and 708, flap 808 is a bendable flap. Removable dental appliance 800 may be the same as or substantially similar to removable dental appliance 100 discussed above in reference to FIGS. 1A-1E, except for the differences describe herein.

As illustrated in FIGS. 8A and 8B, an appliance body 802 includes a bridge 809 extending around an entire flap boundary region 813. As illustrated in FIGS. 8A and 8B, bridge 809 may define a displacement of appliance body 802 away from a plane tangential to the surface of shell 804. As illustrated in the cross-sectional view of FIG. 8B, a thickness of bridge 809 may be substantially less than a thickness 812 of other portions of appliance body 802, including bendable flap 808 and/or the shell. The relatively thinner bridge 809 may be more flexible than the surrounding appliance body 802 or bendable flap 808. Additionally, or alternatively, in some examples, one or more portions of bridge 809 may include slots to reduce shear stress in selected regions. As illustrated in FIG. 8B, bridge 809 may include a continuous spring bellows. The continuous spring bellows may protrude further from the plane around flap boundary region 813. In some examples, bridge 809 may include a plurality of undulations toward and away from the plane tangential to a surface of appliance body 802. Such undulation may improve control of a direction and/or magnitude of force applied by bridge 809 to bendable flap 808.

The bendable flap 808 includes a reduced surface area as compared to flap 608, such that it can be used to concentrate force on a smaller region of or point on a given tooth surface, providing a relatively well-defined point of contact where force is applied. The relatively smaller flap can be advantageous, under certain circumstances, for . . . providing controllable engaged force location, direction, magnitude, or combinations of them resulting in greater tooth movement and control (e.g., translation and/or rotation). These considerations suggest that bendable flap 808 (and others of reduced surface area) may be particularly beneficial for finishing movements at the end stages of treatment, or in stages where tooth movements can be effectuated by a couple (e.g., rotation).

The configuration illustrated in FIGS. 8A and 8B may increase patient comfort by eliminating exposed edges of appliance material, provide substantially greater forces than other examples by increasing the effective length of the spring bellows to include the lateral sides of the flap, and/or reduce buildup of food and plaque, compared to appliance bodies having voids defining arcuate members. In some examples, appliance body 802 may include fillets or chamfers to improve patient comfort and/or reduce buildup of food or plaque in corners or inside edges of appliance body 802. In some examples, appliance body 802 may be thermoformed without the need for post-processing, such as machining or cutting. In some examples, appliance body 802 may be 3D printable without the need for support structures on or near bendable flap 808, depending on appliance orientation in the printer (because of the elimination of exposed edges that might lack localized support).

In general, a respective flap and bridges may be integrally formed with a respective shell on any one of a lingual, facial, or occlusal surface of a respective appliance body. Bendable flaps and bridge(s) may be arranged to effectuate linear translation, rotation, intrusion, extrusion, tipping, and torqueing. In some examples, a plurality of bendable flaps and a plurality of bridges may be on opposing sides of an appliance body. Two or more bendable flaps in such examples may be positioned to form a couple. The couple of forces may result in a rotation of a tooth about an axis approximately centered in the tooth and extending in the occlusal-gingival direction. As another example, one bendable flap may be configured to apply force to a lingual-mesial surface of a tooth opposite from a void to cause movement of tooth toward a void internal to the appliance shell and shaped to receive the tooth in the desired position. In some other examples, a plurality of bendable flaps may be on the same side of an appliance body. In such examples, one bendable flap and/or bridge(s) may be configured to apply force to a surface near the incisal edge of a tooth, with a separate bendable flap bridge(s) combination to apply force to a surface near the gingival margin. These forces may be concentrated at different locations on the tooth, as desired, with similar or dissimilar magnitudes. In some other examples, a plurality of bendable flaps and bridges on the same side of an appliance body may be configured to concentrate a respective plurality of forces. Suitable arrangement for the bendable flaps and bridges of the present disclosure may be found, for example, in U.S. Provisional Patent Application No. 62/832,524, to Raby et al, filed on Apr. 11, 2019, assigned to the present assignee and incorporated by reference in its entirety herein.

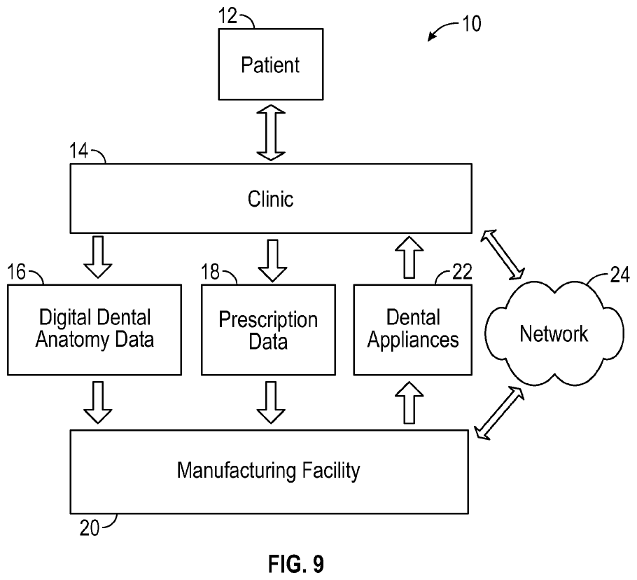

FIG. 9 is a block diagram illustrating an example computer environment 10 in which clinic 14 and manufacturing facility 20 communicate information throughout a manufacturing process of a set of removable dental appliances 22 for patient 12. The set of removable dental appliances 22 may include at least one of removable dental appliances 100, 200, 300, 400, 500, 600, 700, or 800. As discussed above, removable dental appliances 100, 200, 300, 400, 500, 600, 700, or 800 include a plurality of shells, at least one bendable flap, and at least one bridge and/or a hinge. Initially, an orthodontic practitioner of clinic 14 generates one or more images of a dental anatomy of patient 12 using any suitable imaging technique and generates digital dental anatomy data 16 (e.g., a digital representation of patient's 12 tooth structure). For example, the practitioner may generate X-ray images that can be digitally scanned. Alternatively, the practitioner may capture digital images of the patient tooth structure using, for example, conventional computed tomography (CT), laser scanning, intra-oral scanning, CT scans of dental impressions, scans of dental casts poured from impressions, ultrasound instrumentation, magnetic resonance imaging (MRI), or any other suitable method of three-dimensional (3D) data acquisition. In other embodiments, the digital images may be provided using a hand-held intra-oral scanner such as the intra-oral scanner using active wavefront sampling developed by Brontes Technologies, Inc. (Lexington, Mass.) and described in PCT Publication No. WO 2007/084727 (Boerjes, et al.), which is incorporated herein by reference in its entirety. Alternatively, other intra-oral scanners or intra-oral contact probes may be used. As another option, the digital dental anatomy data 16 may be provided by scanning a negative impression of patient's 12 teeth. As still another option, the digital dental anatomy data 16 may be provided by imaging a positive physical model of patient's 12 teeth or by using a contact probe on a model of patient's 12 teeth. The model used for scanning may be made, for example, by casting an impression of patient's 12 dentition from a suitable impression material such as alginate or polyvinylsiloxane (PVS), pouring a casting material (such as orthodontic stone or epoxy resin) into the impression, and allowing the casting material to cure. Any suitable scanning technique may be used for scanning the model, including those described above. Other possible scanning methods are described in U.S. Patent Publication No. 2007/0031791 (Cinader et al.), which is incorporated herein by reference in its entirety.

In addition to providing digital images by scanning the exposed surfaces of the teeth, it is possible to image non-visible features of the dentition, such as the roots of patient's 12 teeth and patient's 12 jaw bones. In some embodiments, the digital dental anatomy data 16 is formed by providing several 3D images of these features and subsequently “stitching” them together. These different images need not be provided using the same imaging technique. For example, a digital image of teeth roots provided with a CT scan may be integrated with a digital image of the teeth crowns provided with an intraoral visible light scanner, for example, as describe in U.S. Patent Application No. 62/787,025, by Raby et al., which in incorporated herein by reference in its entirety. Scaling and registering of two-dimensional (2D) dental images with 3D dental images is described in U.S. Pat. No. 6,845,175 (Kopelman, et al.), which is incorporated herein by reference in its entirety, and U.S. Patent Publication No. 2004/0029068 (Badura, et al.), which is incorporated herein by reference in its entirety. Issued U.S. Pat. No. 7,027,642 (Imgrund, et al.), which is incorporated herein by reference in its entirety, and U.S. Pat. No. 7,234,937 (Sachdeva, et al.), which is incorporated herein by reference in its entirety, describe using techniques of integrating digital images provided from various 3D sources. Accordingly, the term “imaging” as it is used herein is not limited to normal photographic imaging of visually apparent structures but includes imaging of dental anatomies that are hidden from view. The dental anatomy may include, but is not limited to, any portion of crowns or roots of one or more teeth of a dental arch, gingiva, periodontal ligaments, alveolar bone, cortical bone, implants, artificial crowns, bridges, veneers, dentures, orthodontic appliances, or any structure that could be considered part of the dentition before, during, or after treatment.

To generate digital dental anatomy data 16, a computer must transform raw data from the imaging systems into usable digital models. For example, for raw data representing the shapes of teeth received by a computer, the raw data is often little more than a point cloud in 3D space. Typically, this point cloud is surfaced to create 3D object models of the patient's dentition, including one or more teeth, gingival tissue, and other surrounding oral structure. For this data to be useful in orthodontic diagnosis and treatment, the computer may “segment” dentition surfaces to produce one or more discrete, movable 3D tooth object models representing individual teeth. The computer may further separate these tooth models from the gingiva into separate objects.

Segmentation allows a user to characterize and manipulate the teeth arrangement as a set of individual objects. Advantageously, the computer may derive diagnostic information such as arch length, bite setting, interstitial spacing between adjacent teeth, and even American Board of Orthodontics (ABO) objective grading from these models. As a further benefit, the digital orthodontic setups may provide flexibility in the manufacturing process. By replacing physical processes with digital processes, the data acquisition step and data manipulation steps can be executed at separate locations without the need to transport stone models or impressions from one location to another. Reducing or eliminating the need for shipping physical objects back and forth can result in significant cost savings to both customers and manufacturers of customized appliances.

After generating digital dental anatomy data 16, clinic 14 may store digital dental anatomy data 16 within a patient record in a database. Clinic 14 may, for example, update a local database having a plurality of patient records. Alternatively, clinic 14 may remotely update a central database (optionally within manufacturing facility 20) via network 24. After digital dental anatomy data 16 is stored, clinic 14 electronically communicates digital dental anatomy data 16 to manufacturing facility 20. Alternatively, manufacturing facility 20 may retrieve digital dental anatomy data 16 from the central database. Alternatively, manufacturing facility 20 may retrieve preexisting digital dental anatomy data 16 from a data source unassociated with clinic 14.

Clinic 14 may also forward prescription data 18 conveying general information regarding a practitioner's diagnosis and treatment plan for patient 12 to manufacturing facility 20. In some examples, prescription data 18 may be more specific. For example, digital dental anatomy data 16 may be a digital representation of the dental anatomy of patient 12. The practitioner of clinic 14 may review the digital representation and indicate at least one of desired movements, spacing, or final positions of individual teeth of patient 12. For example, the desired movements, spacing, and final positions of individual teeth of patient 12 may affect the forces to be applied to the teeth of patient 12 at each stage of treatment by each removable dental appliance of the set of removable dental appliances 22. As discussed above, the forces applied by each removable dental appliance (e.g., removable dental appliance 100, 200, 300, 400, 500, 600, 700, or 800) of the set of removable dental appliances 22 may be determined by selecting the dimensions, shapes, and positions of at least one of the plurality of shells (e.g., shells 104, 204, 304, 404, 504, 604, 704, or 804), at least one bendable flap (e.g., bendable flaps 108C, 208, 308, 408, 508, 608, 708, or 808), at least one bridge (e.g., arcuate members 109C, 209, 309, 409, 509, 609, 709, or 809), and the like. The at least one of desired movements, spacing, or final positions of individual teeth of patient 12 may enable the practitioner, a technician at manufacturing facility 20, and a computer at manufacturing facility 20 to determine at least one of selected dimensions, shapes, and positions of at least one of the shells, bendable flaps, arcuate members, and reinforcing structures. In this way, digital dental anatomy data 16 may include at least one of practitioner, technician, or computer selected dimensions, shapes, and positions of at least one of shells, bendable flaps, bridges, and optional reinforcing structures of each of removable dental appliance of the set of removable dental appliances 22 to result in the desired movement of the teeth of patient 12. Following review of the digital representation, the digital dental anatomy data 16 that includes the selected dimensions, shapes, and positions of shells, bendable flaps, arcuate members, and reinforcing structures of each removable dental appliance of the set of removable dental appliances 22, may be forwarded to manufacturing facility 20. Manufacturing facility 20 may be located off-site or located with clinic 14.

For example, each clinic 14 may include on-site equipment for manufacturing facility 20 such that a treatment plan and digital design may be performed entirely by a clinical practitioner, or an assistant, in the clinical setting, using software installed locally. The manufacturing may be performed in the clinic, as well, by using a 3D printer (or by other methods of additive manufacturing). A 3D printer allows manufacturing of intricate features of a dental appliance or a physical representation of the dental anatomy of patient 12 through additive printing. The 3D printer may use iterative digital designs of original dental anatomy of patient 12 as well as a desired dental anatomy of patient 12 to produce multiple digital appliances, digital appliance patterns customized to produce the desired dental anatomy of patient 12, or both. Manufacturing may include post-processing to remove uncured resin and remove support structures, or to assemble various components, which may also be necessary and could also be performed in a clinical setting.

Manufacturing facility 20 utilizes digital dental anatomy data 16 of patient 12 to construct the set of removable dental appliances 22 to reposition teeth of patient 12. Sometime thereafter, manufacturing facility 20 forwards the set of removable dental appliances 22 to clinic 14 or, alternatively, directly to patient 12. For example, the set of removable dental appliances 22 may be an ordered set of removable dental appliances. Patient 12 then wears the removable dental appliances 22 in the set of removable dental appliances 22 sequentially over time according to a prescribed schedule to reposition the teeth of patient 12. For example, patient 12 may wear each removable dental appliance in the set of removable dental appliances 22 for a period of between about 1 week and about 6 weeks, such as between about 2 weeks and about 4 weeks, or about 3 weeks. Optionally, patient 12 may return to clinic 14 for periodic monitoring of the progress of the treatment with removable dental appliances 22.

During such periodic monitoring, a clinician may adjust the prescribed schedule of patient 12 for wearing the removable dental appliances in the set of removable dental appliances 22 sequentially over time. Monitoring generally includes visual inspection of the teeth of patient 12 and may also include imaging to generate digital dental anatomy data. In some examples, the clinician may decide to interrupt the treatment of patient 12 with the set of removable dental appliances 22, for example, by sending the newly generated digital dental anatomy data 16 to manufacturing facility 20 in order to produce a new set of removable dental appliances 22. In some examples, the clinician may send newly generated digital dental anatomy data 16 to manufacturing facility 20 following the completion of the prescribed schedule of the treatment with removable dental appliances 22. In some examples, following the completion of the prescribed schedule of the treatment with removable dental appliances 22, the clinician may request a new set of removable dental appliances from manufacturing facility 20 to continue treatment of patient 12.

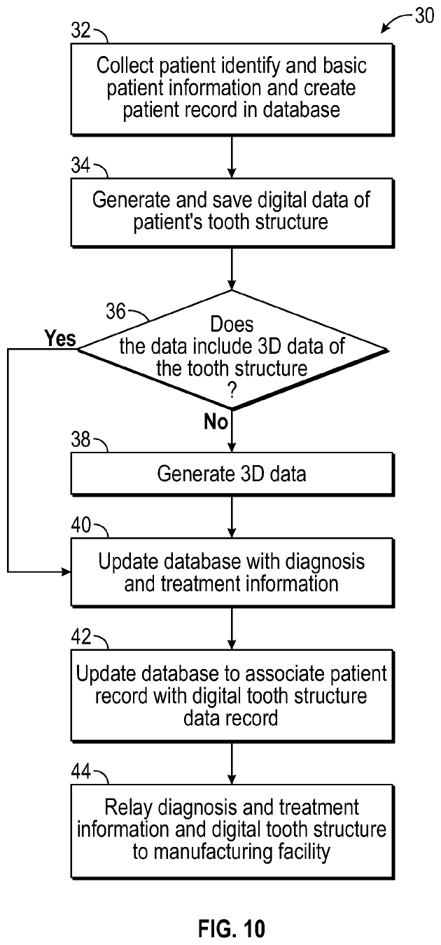

FIG. 10 is a flow diagram illustrating process 30 conducted at clinic 14 in accordance with one example of this disclosure. Initially, a practitioner at clinic 14 collects patient identity and other information from patient 12 and creates a patient record (32). As described above, the patient record may be located within clinic 14 and optionally configured to share data with a database within manufacturing facility 20. Alternatively, or additionally, the patient record may be located within a database at manufacturing facility 20 that is remotely accessible to clinic 14 via network 24 or within a database that is remotely accessible by both manufacturing facility 20 and clinic 14.

Next, digital dental anatomy data 16 of patient 12 may be generated using any suitable technique (34), to thereby create a virtual dental anatomy. Digital dental anatomy data 16 may be comprised of a two-dimensional (2D) image, a three-dimensional (3D) representation of the dental anatomy, or both.

In one example, 3D representations of a dental anatomy are generated using a cone beam computerized tomography (CBCT) scanner, such as an i-CAT 3D dental imaging device (available from Imaging Sciences International, LLC; 1910 N Penn Road, Hatfield, Pa.). Clinic 14 stores the 3D digital dental anatomy data 16 (in the form of radiological images) generated from the CBCT scanner in the database located within clinic 14, or alternatively, within manufacturing facility 20. The computing system processes the digital dental anatomy data 16 from the CBCT scanner, which may be in the form of a plurality of slices, to compute a digital representation of the tooth structure that may be manipulated within the 3D modeling environment.

If 2D radiological images are used (36), then the practitioner may further generate 3D digital data (38). The 3D digital dental anatomy data 16 may be produced by, for example, forming and subsequently digitally scanning a physical impression or casting of the tooth structure of patient 12. For example, a physical impression or casting of a dental arch of patient 12 may be scanned using a visible light scanner, such as an OM-3R scanner (available from Laser Design, Inc. of Minneapolis, Minn.) or an ATOS scanner (available from GOM GmbH of Braunschweig, Germany). Alternatively, the practitioner may generate the 3D digital dental anatomy data 16 of the occlusal service by use of an intra-oral scan of the dental arch of patient 12, or existing 3D tooth data. In one example, the method of forming a digital scan from a casting or an impression described in U.S. Pat. No. 8,491,306, by Raby et al., which is incorporated herein by reference in its entirety, may be used. In the same or different examples, techniques for defining a virtual tooth surface and virtual tooth coordinate system as described in U.S. Patent Application Publication No. 2013/0325431, by See et al., which is incorporated herein by reference in its entirety, may be used. In any case, the digital data are digitally registered within the 3D modeling environment to form a composite digital representation of a tooth structure, which may include the tooth roots as well as the occlusal surfaces.

In one example, 2D radiological images and the 3D digital data for the occlusal surface of the dental arch are registered by first attaching registration markers (e.g., fiducial markers or a pedestal having known geometry) to the tooth structure of patient 12 prior to generating both the radiological images and the 3D digital scan. Thereafter, the digital representation of the registration markers within the 2D radiological image and the 3D digital data may be aligned within a 3D modeling environment using registration techniques described in U.S. Pat. No. 8,491,306.

In another example, 3D digital data of the tooth structure is generated by combining two 3D digital representations of the tooth structure. For example, a first 3D digital representation may be a relatively low-resolution image of the roots obtained from a CBCT scanner (e.g., an i-CAT 3D dental imaging device) and the second 3D digital representation may be a relatively high-resolution image of the crowns of the teeth obtained from an industrial CT scan of an impression or a visible light (e.g., laser) scan of a casting of the dental arch of the patient. The 3D digital representations may be registered using a software program that enables the 3D representations to be manipulated within a computer environment (e.g., Geomagic Studio software (available from 3D Systems, Inc.; 333 Three D Systems Circle, Rock Hill, South Carolina), or alternatively, registration techniques described in U.S. Pat. No. 8,491,306 may be used.

Next, a computer system executing 3D modeling software renders a resultant digital representation of the tooth structure, including the occlusal surface as well as the root structure of the patient's dental arch. Modeling software provides a user interface that allows the practitioner to manipulate digital representations of the teeth in 3D space relative to the digital representation of the patient's dental arch. By interacting with the computer system, the practitioner generates treatment information, such as by selecting indications of the desired positions, final positions, or both of individual teeth of patient 12, duration of a respective stage of treatment, or number of treatment stages, the direction or magnitude of forces on the teeth of patient 12 during a stage of treatment, or the like (40). In some examples, bendable flaps may be used during at least one, but fewer than all stages of treatment. For example, the desired positions of individual teeth of patient 12, duration of a respective stage of treatment, or number of treatment stages may affect the direction or magnitude of forces on the teeth of patient 12 at each stage of treatment by each removable dental appliance of the set of removable dental appliances 22. As discussed above, the forces applied by each removable dental appliance (e.g., removable dental appliances 100, 200, 300, 400, 500, 600, 700, or 800) of the set of removable dental appliances 22 may be determined by selecting the dimensions, shapes, and positions of at least one of the plurality of shells (e.g., shells 104, 204, 304, 404, 504, 604, 704, or 804), bendable flaps (e.g., bendable flaps 108C, 208, 308, 408, 508, 608, 708, or 808) at least one bridge (e.g., bridges 109C, 209, 309, 310, 409, 509, 609, 709, or 809), optional reinforcing structures, and the like. In this way, updating the database with diagnostic and treatment information (40) may include determining or selecting by the practitioner, a technician, or automatically by a computer the dimensions, shapes, and positions of the plurality of shells, at least one bendable flap, at least one reinforcing structure, and the like of each of removable dental appliance of the set of removable dental appliances 22 to result in the desired movement of the teeth of patient 12.

Once the practitioner has finished conveying general information regarding a diagnosis and treatment plan within the 3D environment, the computer system updates the database associated with the patient record to record the prescription data 18 conveying general information regarding a diagnosis and treatment plan as specified by the practitioner (42). Thereafter, the prescription data 18 is relayed to manufacturing facility 20 for manufacturing facility 20 to construct one or more removable dental appliances including at least one bendable flap, such as removable dental appliances 22 (44).

Although described with respect to an orthodontic practitioner located at an orthodontic clinic, one or more of the steps discussed with respect to FIG. 10 may be performed by a remote user, such as a user located at manufacturing facility 20. For example, the orthodontic practitioner may only send radiological image data and an impression or casting of the patient to manufacturing facility 20, where a user interacts with a computer system to develop a treatment plan within a 3D modeling environment. Optionally, a digital representation of the treatment plan within the 3D modeling environment may then be transmitted to the orthodontic practitioner of clinic 14, who may review the treatment plan and either send back his or her approval, or indicate desired changes.

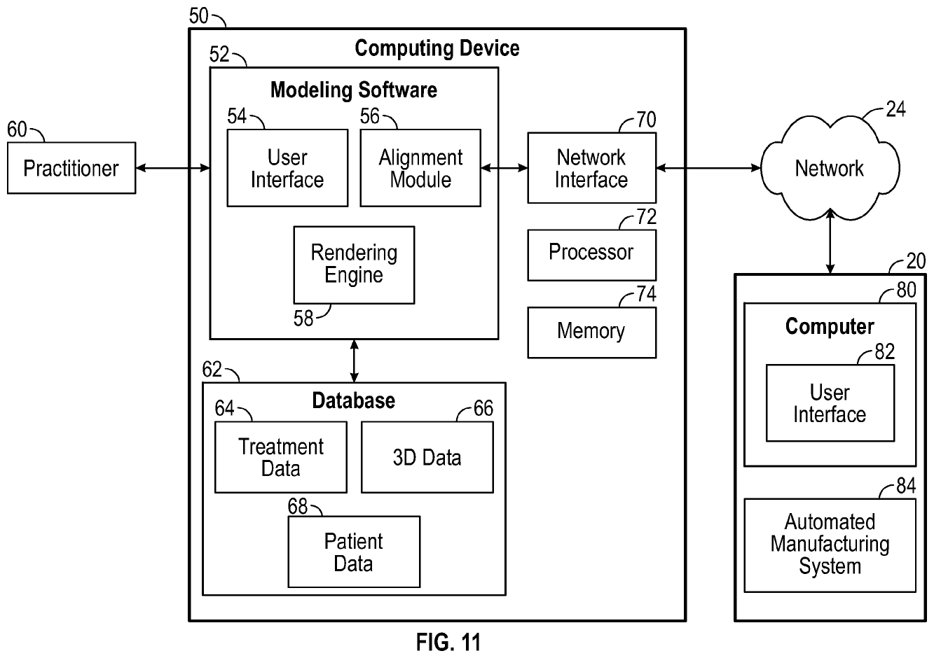

FIG. 11 is a block diagram illustrating an example of a client computer 50 connected to manufacturing facility 20 via network 24. In the illustrated example, client computer 50 provides an operating environment for modeling software 52. Modeling software 52 presents a modeling environment for modeling and depicting the 3D representation of the teeth of patient 12. In the illustrated example, modeling software 52 includes user interface 54, alignment module 56, and rendering engine 58.

User interface 54 provides a graphical user interface (GUI) that visually displays the 3D representation of patient's 12 teeth. In addition, user interface 54 provides an interface for receiving input from practitioner 60 of clinic 14, e.g., via a keyboard and a pointing device, a touchscreen, or the like, for manipulating patient's 12 teeth within the modeled dental arch.

Modeling software 52 may be accessible to manufacturing facility 20 via network interface 70. Modeling software 52 interacts with database 62 to access a variety of data, such as treatment data 64, 3D data 66 relating to the tooth structure of patient 12, and patient data 68. Database 62 may be represented in a variety of forms including data storage files, lookup tables, or a database management system (DBMS) executing on one or more database servers. The database management system may be a relational (RDBMS), hierarchical (HDBMS), multi-dimensional (MDBMS), object oriented (ODBMS or OODBMS) or object relational (ORDBMS) database management system. The data may, for example, be stored within a single relational database, such as SQL Server from Microsoft Corporation. Although illustrated as local to client computer 50, database 62 may be located remote from the client computer 50 and coupled to the client computer 50 via a public or private network, e.g., network 24.

Treatment data 64 describes diagnosis or repositioning information for the teeth of patient 12 selected by practitioner 60 and positioned within the 3D modeling environment. For example, treatment data 64 may include the dimensions, shapes, and positions of at least one of the plurality of shells (e.g., shells 104, 204, 304, 404, 504, 604, 704, or 804), bendable flaps (e.g., bendable flaps 108C, 208, 308, 408, 508, 608, 708, or 808) at least one bridge (e.g., bridges 109C, 209, 309, 310, 409, 509, 609, 709, or 809), optional reinforcing structures, and the like. that may result in a selected magnitude and direction of force vectors to be applied to teeth of a patient (e.g., teeth 103) throughout the treatment plans.

Patient data 68 describes a set of one or more patients, e.g., patient 12, associated with practitioner 60. For example, patient data 68 specifies general information, such as a name, birth date, and a dental history, for each patient 12.

Rendering engine 58 accesses and renders 3D data 66 to generate the 3D view presented to practitioner 60 by user interface 54. More specifically, 3D data 66 includes information defining the 3D objects that represent each tooth (optionally including roots), and jaw bone within the 3D environment. Rendering engine 58 processes each object to render a 3D triangular mesh based on viewing perspective of practitioner 60 within the 3D environment. User interface 54 displays the rendered 3D triangular mesh to practitioner 60, and allows practitioner 60 to change viewing perspectives and manipulate objects within the 3D environment.

U.S. Pat. No. 8,194,067, to Raby et al., which is incorporated by reference in its entirety, and U.S. Pat. No. 7,731,495, by Eisenberg, which is incorporated by reference in its entirety, describe other examples for computer systems and 3D modeling software having user interfaces that may be used with the techniques described herein.

Client computer 50 includes processor 72 and memory 74 to store and execute modeling software 52. Memory 74 may represent any volatile or non-volatile storage elements. Examples include random access memory (RAM) such as synchronous dynamic random access memory (SDRAM), read-only memory (ROM), non-volatile random access memory (NVRAM), electrically erasable programmable read-only memory (EEPROM), and FLASH memory. Examples may also include non-volatile storage, such as a hard-disk, magnetic tape, a magnetic or optical data storage media, a compact disk (CD), a digital versatile disk (DVD), a Blu-ray disk, and a holographic data storage media.

Processor 72 represents one or more processors such as a general-purpose microprocessor, a specially designed processor, an application specific integrated circuit (ASIC), a field programmable gate array (FPGA), a collection of discrete logic, or any type of processing device capable of executing the techniques described herein. In one example, memory 74 may store program instructions (e.g., software instructions) that are executed by processor 72 to carry out the techniques described herein. In other examples, the techniques may be executed by specifically programmed circuitry of processor 72. In these or other ways, processor 72 may be configured to execute the techniques described herein.

Client computer 50 is configured to send a digital representation of a 3D tooth structure of a patient, and optionally, treatment data 64 and/or patient data 68 to computer 80 of manufacturing facility 20 via network 24. Computer 80 includes user interface 82. User interface 82 provides a GUI that visually displays the 3D representation of the digital model of teeth. In addition, user interface 82 provides an interface for receiving input from a user, e.g., via a keyboard and a pointing device, for manipulating teeth of a patient within the digital representation of the 3D tooth structure of the patient.

Computer 80 may further be configured to automatically determine dimensions and shapes of each removable dental appliance of a set of removable dental appliances 22. The dimensions and shapes of removable dental appliance 22 may include a position, dimension, and shape (e.g., at least one of at least one position, at least one dimension, and at least one shape) of at least one of the plurality of shells, at least one bendable flap, at least one arcuate member, at least one reinforcing structure, and the like, such that removable dental appliance 22 is configured to reposition the one or more teeth from their initial positions to final positions when the removable dental appliance is worn by the patient. As discussed above with respect to FIGS. 1-17, the position, dimension, and shape of at least one of the plurality of shells (e.g., shells 104, 204, 304, 404, 504, 604, 704, or 804), bendable flaps (e.g., bendable flaps 108C, 208, 308, 408, 508, 608, 708, or 808) at least one bridge (e.g., bridges 109C, 209, 309, 310, 409, 509, 609, 709, or 809), optional reinforcing structures, and the like. may affect the magnitude, direction, and length of expression of a force applied to the teeth when the removable dental appliance is worn by the patient. For example, the position, dimensions, and shape of a respective bendable flap and/or arcuate member may determine, at least in part, the magnitude, direction, and length of expression of the force resulting from a deformation of the bendable flap and/or arcuate member when the removable dental appliance is worn by the patient. The position, dimensions, and shape of the arcuate member and/or an optional reinforcing structure may concentrate deformation in selected regions of a respective bendable flap to control the direction of force applied to the teeth. Also, the position, dimensions, and shape of a respective shell of the plurality of shells may affect the location(s) of engagement of a respective shell with a respective tooth. The location(s) of engagement may affect the direction of the force applied to the respective tooth. Computer 80 may analyze at least one of the magnitude, direction, and length of expression of at least one force resulting from a deformation of the respective bendable flap and/or arcuate member when the removable dental appliance is worn by the patient to determine at least one of position, dimension, and shape of a respective shell, a respective bendable flap, a respective arcuate member, a respective reinforcing structure, or the like that will result in a desired movement of a respective tooth of a patient when the removable dental appliance is worn by the patient.

Computer 80 may present a representation of the removable dental appliance 22 for user to review, including review of dimensions and shapes. Alternatively, or additionally, computer 80 may accept input from a user to determine dimensions and shapes of a set of removable dental appliances 22 for patient 12. For example, the user input may influence at least one of an automatically determined dimensions or shapes. Computer 80 may transmit, or otherwise send, a digital model of the set of removable dental appliance 22, the dimensions and shapes of the set of removable dental appliances 22, or both, to computer-aided manufacturing system 84 for production of the set of removable dental appliances 22.

Client computer 50 and computer 80 are merely conceptual representations of an example computer system. In some examples, the functionalities described with respect to client computer 50, computer 80, or both may be combined into a single computing device or distributed among multiple computing devices within a computer system. For example, cloud computing may be used for digital design of dental appliances described herein. In one example, the digital representations of tooth structures are received at one computer at the clinic, while a different computer, such as computer 80, is used to determine the shapes and dimensions of a removable dental appliance. In addition, it may not be necessary for that different computer, such as computer 80, to receive all of the same data in order for it determine shapes and dimensions. Shapes and dimensions may be determined, at least in part, based on knowledge derived through analysis of historical cases or virtual models of exemplary cases, without receiving a complete 3D representation of the case in question. In such an example, data transmitted between client computer 50 and computer 80, or otherwise utilized to design a custom dental appliance may be significantly less than the complete data set representing a complete digital dental model of a patient.

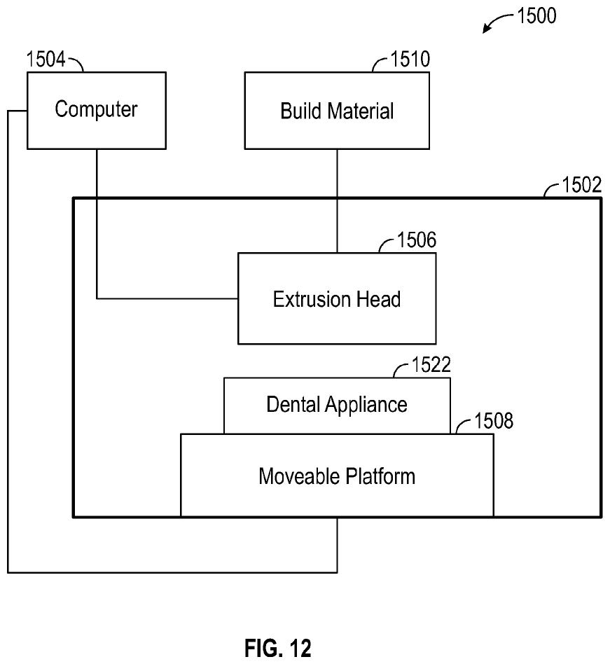

FIG. 12 is a block diagram illustrating an example computer-aided manufacturing system 1500 for construction of removable dental appliance 1522. The example of computer-aided manufacturing system 1500 includes an additive manufacturing system 1502 in communication with computer 1504 and coupled to build material source 1510. In some examples, computer-aided manufacturing system 1500 may include computer-aided manufacturing system 84 of FIG. 20. For example, computer 1504 may be the same as or substantially similar to computer 80. Build material source 1510 includes a source of at least one polymeric material, such as, for example, at least one of the polymeric materials of appliance body 102 discussed above. Dental appliance 1522 may be the same as or substantially similar to at least one of removable dental appliances 100, 200, 300, 400, 500, 600, 700, or 800. In some examples, dental appliance 1522 includes one dental appliance of a set of dental appliances 22.

Additive manufacturing system 1502 includes a moveable platform 1508 and an extrusion head 1506. Movable platform 1508 and extrusion head 1506 are configured to manufacture dental appliance 1522. For example, computer 1504 controls extrusion head 1506 and moveable platform 1508 to manufacture removable dental appliance 1522. Controlling, by computer 1504, extrusion head 1506 may include at least one of controlling a material feed rate from build material source 1510 to extrusion head 1506, controlling a deposition rate of build material on dental appliance 1522, controlling a temperature of extrusion head 1506, and controlling a position of extrusion head 1506. By controlling at least one of a material feed rate, a material deposition rate, a temperature of extrusion head 1506, and a position of extrusion head 1510, computer 1504 may control manufacture of a position, dimension, and shape of at least a portion of dental appliance 1522. Controlling, by computer 1504, movable platform 1508 may include at least one of controlling a translation of moveable platform in a plane normal to the direction of material deposition from extrusion head 1506 and controlling an elevation of moveable platform along an axis substantially parallel to the direction of material deposition from extrusion head 1506. By controlling at least one of a translation and elevation of moveable platform 1508, computer 1504 may control manufacture of a position, dimension, and shape of at least a portion of dental appliance 1522.

Although FIG. 12 illustrates a computer-aided manufacturing system 1500 configured for Fused Deposition Modeling (FDM), computer-aided manufacturing system 1500 may also be configured for stereolithography (SLA), inverse vat polymerization additive manufacturing, inkjet/polyjet additive manufacturing, or other methods of additive manufacturing. In examples in which computer-aided manufacturing system 1500 is configured for polyjet printing, computer-aided manufacturing system 1500 may be configured to print multiple materials in a single print, thereby allowing a high modulus material for the rigid components of dental appliance 1522 (e.g., shells) and a low modulus or elastomeric material for the less rigid components of dental appliance 1522 (e.g., bendable flaps and/or arcuate members). Further, with polyjet additive manufacturing, the modulus may be varied selectively across the dental appliance 1522, and a different modulus may be used for the bendable flaps and/or arcuate members than is used for the shells, for different parts of a bendable flap and/or arcuate members, or for different parts of a shell, for example. Similarly, a different modulus may be used for the anchoring shells than is used for the shell used to reposition individual teeth.

Additionally, or alternatively, manufacturing a dental appliance may include thermoforming and using a femtosecond laser controlled by a multi-axis robot or CNC machine to cut away material, such as to form slots, hinges, and spring features. In some instances, cut depth may be controlled to selectively ablate material and reduce the thickness of the appliance in certain areas, such as to form a more flexible hinge axis or to increase the flexibility of a spring element.

Additionally, or alternatively, manufacturing a dental appliance may include forming at least a portion of the appliance, if not the entire appliance, by milling or otherwise machining the appliance from a solid block of material.

Additionally, or alternatively, manufacturing a dental appliance may include, especially where varying thickness or reinforcements are needed, thermoforming the appliance body, and using a multi-axis robot to dispense, via a heated extrusion nozzle, hot thermoplastic material onto an appliance of otherwise uniform thickness. This can serve to create structures of greater thickness in areas. In similar fashion, a photocurable resin may be dispensed onto the surface and light cured, either immediate after dispensing or after all features have been laid down.

Additionally, or alternatively, manufacturing a dental appliance may include, the prefabrication of bendable flaps and/or arcuate members. The prefabricated bendable flaps and/or arcuate members may include material such as stainless steel, titanium, or nickel titanium (NiTi), and bonded or fastened to the appliance body which is formed by other means, such as by thermoforming or 3D printing. The advantage in this approach is to allow for smaller structures having greater force delivery. In such cases, the computing device would be used to select from among a discrete set of premanufactured flaps the meet the required force and deflection criteria to achieve the prescribed movement, and place to determine the best position(s) for placement on each tooth.

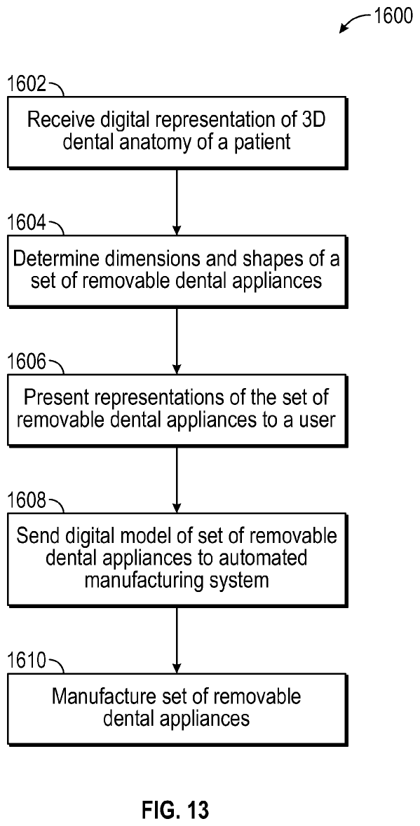

FIG. 13 is a flow diagram illustrating process 1600 conducted at manufacturing facility 20 for construction of set of removable dental appliances 22. In some examples, set of removable dental appliances 22 may include at least one of removable dental appliance 100, 200, 300, 400, 500, 600, 700, or 800 Computer 80 at manufacturing facility 20 receives digital dental anatomy data 16 including initial positions of one or more teeth of the patient and prescription data 18 (1602) from clinic 14. Alternatively, computer 80 may retrieve the information from a database located within or otherwise accessible by computer 80. A trained user associated with computer 80 may interact with a computerized modeling environment running on computer 80 to develop a treatment plan relative to the digital representation of the patient's tooth structure and generate prescription data 18, if clinic 14 has not already done so. In other examples, computer 80 may automatically develop a treatment plan based solely on the patient's tooth structure and predefined design constraints.

Once computer 80 receives patient's tooth structure, computer 80 determines dimensions and shapes of a removable dental appliance for the patient (1604). The dimensions and shapes of the removable dental appliance are configured to reposition the one or more teeth of the patient from their initial positions to desired positions when the removable dental appliance is worn by the patient. In the same or additional examples, computer 80 determines dimensions and shapes of set of removable dental appliances 22 for the patient configured to be worn in series.

In some examples, determining dimensions and shapes of the removable dental appliance includes selecting, with computer 80, the dimensions and shapes of the removable dental appliance according to a set of predefined design constraints. The set of predesigned design constraints may include one or more factors, including, but not limited to, at least one of a minimum and a maximum localized force applied to one or more of the surrounded teeth, at least one of a minimum and a maximum rotational force applied to one or more of the surrounded teeth, at least one of a minimum and a maximum translational force applied to one or more of the surrounded teeth, at least one of a minimum and a maximum total force applied to one or more of the surrounded teeth, and at least one of a minimum and a maximum stress or strain applied to the removable dental appliance, when the removable dental appliance is worn by the patient and the surrounded teeth are in their initial positions.

Computer 80 may use finite element analysis (FEA) techniques to analyze forces on the teeth of a patient as well as the removable dental appliance during the determination of the dimensions and shapes of the removable dental appliance. For example, computer 80 may apply FEA to a solid model of the teeth of a patient as the modeled teeth move from their initial positions to their final positions representing a treatment including an ordered set of removable dental appliances. Computer 80 may use FEA to select the appropriate removable dental appliance to apply the desired forces on the teeth. In addition, computer 80 may use a virtual articulator to determine contact points between the teeth throughout the movement of the modeled teeth during the treatment. Computer 80 may further include occlusal contact forces, such as interdigitation forces, in the FEA forces analysis in combination with forces from the removable dental appliance during the design of dental appliances in an ordered set of removable dental appliances. Computer 80 may further determine an order in which teeth are to be moved to optimize the application of forces, reduce treatment time, improve patient comfort, or the like.

In some examples, determining dimensions and shapes of a removable dental appliance (e.g., removable dental appliance 100, 200, 300, 400, 500, 600, 700, or 800) includes selecting, with computer 80 thicknesses of the appliance body (e.g., appliance body 102, 202, 302, 402, 502, 602, 702, and 802) at least one of the plurality of shells (e.g., shells 104, 204, 304, 404, 504, 604, 704, or 804), bendable flaps (e.g., bendable flaps 108C, 208, 308, 408, 508, 608, 708, or 808) at least one bridge (e.g., bridges 109C, 209, 309, 310, 409, 509, 609, 709, or 809), optional reinforcing structures, and the like, to provide a stiffness suitable to reposition the one or more teeth of the patient from their initial positions to final positions when the removable dental appliance is worn by the patient. In some examples, the selected thickness may range between about 0.10 millimeters and about 2.0 millimeters, such as between about 0.2 and about 1.0 millimeters, or between about 0.3 millimeters and about 0.75 millimeters. In some examples, computer 80 may further select a material of the removable dental appliance according to the predefined design constraints.

The dimensions and shapes of a removable dental appliance for the patient may be presented to a user via user interface of 82 of computer 80 (1606). In examples in which dimensions and shapes of the removable dental appliance are presented to a user via user interface of 82, the user may have the opportunity to adjust the design constraints or directly adjust the dimensions and shapes of removable dental appliance before the design data is sent to computer-aided manufacturing system 84. In some examples, the dimensions and shapes of the removable dental appliance may be presented to a user by computer 80 directly as the removable dental appliance is manufactured by computer-aided manufacturing system 84. For example, computer 80 may send a digital model of the removable dental appliance to computer-aided manufacturing system 84, and computer-aided manufacturing system 84 manufactures removable dental appliance according to the digital model from computer 80.

However, even in examples where the dimensions and shapes of a removable dental appliance for the patient may be presented to a user via user interface of 82 of computer 80, following user approval, computer 80 sends a digital model of the removable dental appliance to computer-aided manufacturing system 84 (1608), and computer-aided manufacturing system 84 manufactures the removable dental appliance according to the digital model from computer 80 (1610).

In some examples, computer-aided manufacturing system 84 may include a 3D printer. Forming appliance body (e.g., appliance body 102, 202, 302, 402, 502, 602, 702, 802, 902, 1002, and 1102) may include printing the surfaces of at least one of the plurality of shells (e.g., shells 104, 204, 304, 404, 504, 604, 704, or 804), bendable flaps (e.g., bendable flaps 108C, 208, 308, 408, 508, 608, 708, or 808) at least one bridge (e.g., bridges 109C, 209, 309, 310, 409, 509, 609, 709, or 809), optional reinforcing structures, or the like with the 3D printer. In other examples, forming appliance body may include printing representations of the teeth of a patient (e.g., teeth 103) with the 3D printer, thermoforming appliance body over the representations of the teeth of a patient, and trimming excess material (optionally automated by CNC or robotic machinery such as, e.g., end mill or LASER cutter) to form the plurality of shells, at least one bendable flap, at least one arcuate member, at least one reinforcing structure, and like. The representations of the teeth of a patient may include raised surfaces to facilitate forming at least one of the plurality of shells, the at least one bendable flap, at least one arcuate member, at least one reinforcing structure, and the like, in the thermoformed and trimmed appliance body.

The techniques of FIG. 13 may be applied to design and manufacture of each of an ordered set of removable dental appliances 22. For example, each removable dental appliance in the ordered set of removable dental appliances 22 may be configured to incrementally reposition the teeth of the patient. In this manner, the ordered set of removable dental appliances 22 may be configured to reposition the teeth of the patient to a greater degree than any one of the removable dental appliances within the set of the removable dental appliances 22. Such an ordered set of removable dental appliances 22 may specifically be configured to incrementally reposition the one or more teeth of the patient from their initial positions to desired positions as the removable dental appliances of the ordered set of removable dental appliances 22 for the patient are worn sequentially by the patient.

In some examples, the techniques described with respect to FIG. 13 may be embodied within a computer-readable storage medium, such as a computer-readable storage medium of computer 50, computer 80, or both. The computer-readable storage medium may store computer-executable instructions that, when executed, configure a processor to perform the techniques described with respect to FIG. 13.

Following the design of set of removable dental appliances 22, manufacturing facility 20 fabricates set of removable dental appliances 22 in accordance with the digital dental anatomy data 16 and prescription data 18 (1610). Construction of removable dental appliances 22 may include 3D printing, thermoforming, injection molding, lost wax casting, 5-axis milling, laser cutting, hybrid plastic and metal manufacturing techniques, such as snap-fitting and overmolding, as well as other manufacturing techniques.

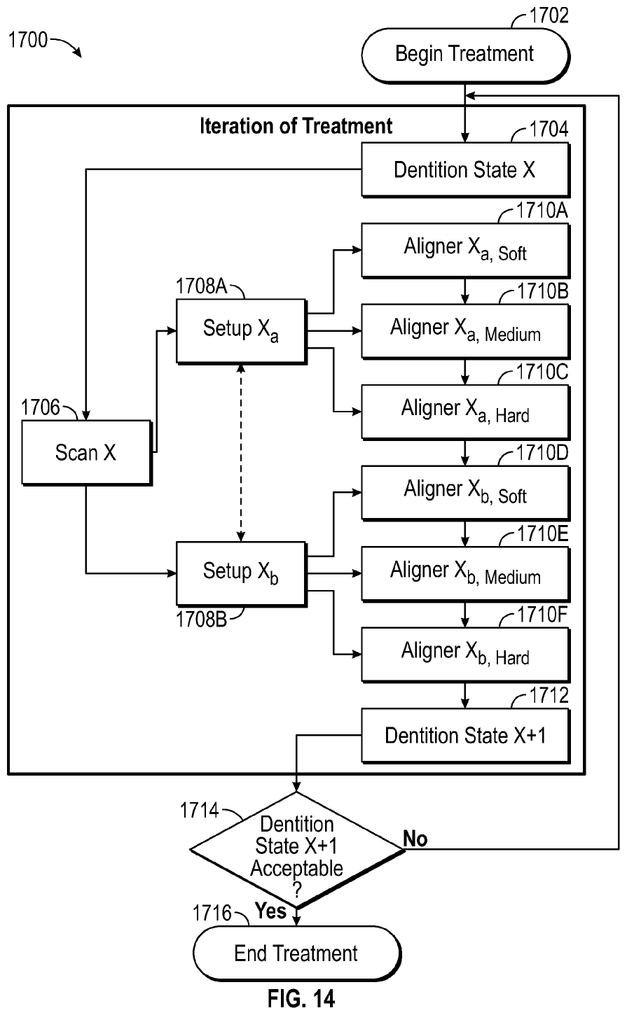

FIG. 14 is a flow diagram 1700 illustrating successive iterations of treatment using an ordered set of removable dental appliances. The ordered set of removable dental appliances is configured to reposition one or more teeth of a patient. In some examples, the ordered set of removable dental appliances may include at least one of removable dental appliances 100, 200, 300, 400, 500, 600, 700, or 800.

Treatment begins with the first iteration of treatment (1702). At the beginning of the first iteration of treatment, the teeth of a patient are at their initial positions as represented by detention state X (1704). A scan of the teeth of a patient, for example, as described above with respect to FIG. 18, are taken to facilitate the design of the ordered set of removable dental appliances (1706). From the scan of teeth of a patient, a computer, e.g., computer 50, determines at least one, such as two, different shapes and dimensions for removable dental appliances in the ordered set: first setup Xₐ 1708A and second setup X_{b} 1708B. Example techniques for creating a digital model of the teeth of a patient are described in U.S. Pat. No. 8,738,165 to Cinader, et al., which is incorporated herein by reference in its entirety. The computer may determine first setup Xₐ 1708A and second setup X_{b} 1708B by first adjusting the digital model of the teeth of a patient to create a model of the desired position of the teeth of a patient following the therapy. Then, the computer may create the shape and dimensions for removable dental appliances in the ordered set based on the time and forces required to move the teeth of a patient from the initial positions to their desired positions. For example, the computer model may adjust the thicknesses, positions, shapes, and dimensions of at least one of the plurality of shells, at least one bendable flap, at least one reinforcing structure, and the like of the removable dental appliances in the ordered set to produce the forces required to move the teeth of a patient from the initial positions to the desired positions. The modeled forces applied by removable dental appliances in the ordered set may further be based on the incremental positional movements of the teeth of a patient during the treatment. In this manner, the computer may design each of the removable dental appliances in the ordered set according to expected forces applied on the teeth in the predicted positions of the teeth at the time during the treatment the removable dental appliances in the ordered set is to be worn by the patient.

In some examples, at least one, such as three, different removable dental appliances in the set of removable dental appliances can be manufactured using each of first setup Xₐ 1708A and second setup X_{b} 1708B to produce at least two, such as six, removable dental appliances in the set of removable dental appliances. For example, first setup Xₐ 1708A may be used to manufacture first removable dental appliance (RDA) X_{a, SOFT} 1710A, second RDA X_{a, MEDIUM} 1710B, and third RDA X_{a, HARD} 1710C; and second setup X_{b} 1708B may be used to manufacture fourth RDA X_{b, SOFT} 1710D, fifth RDA X_{b, MEDIUM} 1710E, and sixth RDA X_{b, HARD} 1710F. First, second, and third RDAs 1710A to 1710C may be substantially the same shape and dimensions, but may comprise materials with different stiffness characteristics. For example, the second and third RDAs 1710B and 1710C may have higher stiffness characteristics than first RDA 1710A, and third RDA 1710C may have higher stiffness characteristics than second RDA 1710B. Similarly, the fourth, fifth, and sixth RDAs 1710D to 1710F may be substantially the same shape and dimensions, but comprise materials with different stiffness characteristics. In some examples, first RDA 1710A may have the same stiffness characteristics as the fourth RDA 1710D, such as a relatively soft polymeric material. Similarly, second RDA 1710B may have the same stiffness characteristics as the fifth RDA 1710E, such as a relatively stiffer polymeric material than first RDA 1710A. Likewise, third RDA 1710C may have the same stiffness characteristics as the sixth RDA 1710F, such as a relatively stiffer polymeric material than second RDA 1710B.

RDAs 1710A to 1710F in the ordered set of removable dental appliances may be worn in sequence over time by the patient. For example, each of RDAs 1710A to 1710F in the ordered set of removable dental appliances may be worn between about 1 week and about 6 weeks, such as between about 2 weeks and about 4 weeks, or about 3 weeks. Following the treatment plan using RDAs 1710A to 1710F, the teeth of a patient may be at their final positions for the first iteration of treatment as represented by detention state X+1 (1712).

Once teeth of a patient are at or near dentition state X+1, the patient may return to the clinician who may evaluate the result of the first iteration of treatment (1714). If the first iteration of treatment has resulted in acceptable final positions of the teeth of a patient, then the treatment may be ended (1716). However, if the first iteration of treatment did not result in acceptable final positions of the teeth of a patient, one or more additional iterations of treatment may be performed. To begin the next iteration of treatment, the clinician may take another scan of the teeth of a patient to facilitate the design of a subsequent ordered set of removable dental appliances (1706). In some examples, evaluation of the result of the first iteration of treatment may include taking another scan of the teeth of a patient, in which case beginning the next iteration of treatment may simply involve forwarding the digital model of the teeth of a patient to a manufacturing facility so that another ordered set of removable dental appliances may be manufactured for the patient based on the new positions of the teeth of a patient. In yet other examples, the newly acquired scan may be used to create one or more iterations of removable dental appliances in the clinician's facility.

The techniques of FIG. 14 represent one specific example, and a variety of modifications may be made to the techniques of FIG. 14 within the spirit of this disclosure. For example, an ordered set of removable dental appliances may include more or less than six removable dental appliances. As another example, each removable dental appliance in the ordered set of removable dental appliances may have unique shapes and dimensions, and each removable dental appliance in the ordered set of removable dental appliances may be made of material having substantially the same or similar stiffness characteristics.

Various examples have been described. These and other examples are within the scope of the following claims.

1. A removable dental appliance comprising:
an appliance body configured to at least partially surround a plurality of teeth of a patient, the appliance body defining a shell configured to receive a tooth of the plurality of teeth in an initial position; and
a flap tethered to the appliance body by at least a bridge, wherein the flap defines a flap boundary region extending around the perimeter of the flap, and wherein the bridge extends between the body and the flap at or adjacent the boundary region,
wherein the flap and the bridge are configured to apply a force to the tooth to cause movement of the tooth toward a desired position and orientation when the removable dental appliance is worn by the patient.

2. The removable dental appliance of claim 1, wherein the flap is integrally formed with the appliance body to extend from a hinge, and wherein the flap is bendable about an axis defined by the hinge.

3. The removable dental appliance of claim 1, wherein the bridge is an arcuate member and comprises a spring bellows extending away from a plane of the shell, wherein a thickness of the spring bellows is less than a thickness of the shells to at least one of concentrate strain in the at least one spring bellows or reduce deformation of the shell when the removable dental appliance is worn by the patient.

4. (canceled)

5. The removable dental appliance of claim 3, wherein a thickness of the spring bellows varies along the flap boundary region.

6. The removable dental appliance of claim 3, wherein the spring bellows defines a shear reduction region.

7. The removable dental appliance of claim 3, wherein the spring comprises a plurality of spring bellows, wherein each respective spring bellows of the plurality of spring bellows is disposed along a respective portion of the flap boundary region.

8. The removable dental appliance of claim 3, the spring bellows comprises at least one of an arc, zig-zag, sinusoid, a pulsed wave, or serpentine shape.

9. The removable dental appliance of claim 1, wherein the flap is tethered to the appliance body only through the bridge.

10. The removable dental appliance of claim 3, wherein the spring bellows continuously extends along the entirety of the boundary region.

11. The removable dental appliance of claim 1, wherein bridge includes a jumper comprising an elongated structure extending between a first end coupled to the body and a second end coupled to the flap.

12. The removable dental appliance of claim 11, wherein the jumper comprises at least one of an arc, zig-zag, sinusoid, spiral, helix, or serpentine shape extending between the first end and the second end of the jumper.

13. The removable dental appliance of claim 11, wherein the jumper defines a cross-section in a plane perpendicular to a longitudinal axis of the elongated structure of the jumper, and wherein the shape, area, or aspect ratio of the cross-section varies along the longitudinal axis.

14. The removable dental appliance of claim 11, wherein the jumper is under a bending stress or a twisting stress when the removable dental appliance is worn by the patient.

15. The removable dental appliance of claim 11, wherein the jumper is more flexible than the shell to at least one of reduce deformation of the shell or concentrate stress in the jumper when the removable dental appliance is worn by the patient.

16. The removable dental appliance of claim 11, wherein the jumper comprises a plurality of jumpers, wherein each respective jumper of the plurality of jumpers comprises a respective elongated structure extending between a respective first end coupled to a respective position on the shell and a respective second end coupled to a respective position on the flap.

17. The removable dental appliance of claim 1,
wherein the shell comprises an internal surface that defines a void internal to the shell and shaped to receive the tooth in the desired position, and
wherein the flap and the bridge are configured to apply the force to a side of the tooth opposite from the void to cause movement of the tooth toward the void.

18. The removable dental appliance of claim 17, wherein the internal surface of the shell further defines a second portion of the void, wherein the removable dental appliance further comprises a second flap tethered to the appliance body wherein the second flap defines a second boundary region at least partially surrounding a perimeter of the flap, wherein the second boundary region comprises a second bridge, and wherein the second flap and the second bridge are configured to apply a second force to a second side of the tooth opposite from the second portion of the void to cause movement of the tooth toward the second portion of the void.

19. The removable dental appliance of claim 1,
wherein a rest position of the flap intrudes into a space defined by the tooth in the desired position of the tooth, and
wherein the flap is displaced into a deformed position to cause the force when the removable dental appliance is worn by the patient.

20. The removable dental appliance of claim 1, wherein the flap includes at least two discrete flap portions, the flap portions capable of movement independent of one another.

21. (canceled)

22. The removable dental appliance of claim 1, wherein the flap defines a plurality of boundary regions defining a spiral configuration, wherein the flap comprises a plurality of flaps, wherein the plurality of bendable flaps defines a plurality of boundary regions defining a spiral configuration.

23. A method comprising:
forming a model of dental anatomy of a patient; and
forming, based on the model, a removable dental appliance comprising the removable dental appliance of claim 1.

24. A method comprising:
receiving, by a computing device, a digital representation of a three-dimensional (3D) dental anatomy of a patient, the dental anatomy providing initial positions of a plurality of teeth of the patient;
determining, by the computing device, dimensions and shapes of a removable dental appliance comprising the removable dental appliance of claim 1,
wherein the dimensions and shapes are configured to reposition the one or more teeth of the patient from an initial position to a desired position when the removable dental appliance is worn by the patient, and wherein the dimensions and shapes comprise:
a position, dimension, and shape of the shell;
a position, dimension, and shape of the flap; and
a position, dimension, and shape of the bridge; and
transmitting, by the computing device, a representation of the removable dental appliance to a computer-aided manufacturing system.
